(19) United States
(12) Patent Application Publication
(10) Pub. No.: US 2024/0166455 A1
(43) Pub. Date: May 23, 2024

(54) PICK AND THROW HARVESTING

(71) Applicant: John Bean Technologies Corporation, Chicago, IL (US)

(72) Inventors: Jon A. Hocker, Redmond, WA (US); George R. Blaine, Lake Stevens, WA (US); Harrison T. Gill, Redmond, WA (US); Jonathan Keogh, Renton, WA (US); Erick A. Sorenson, Shoreline, WA (US)

(73) Assignee: John Bean Technologies Corporation, Chicago, IL (US)

(21) Appl. No.: 18/425,651

(22) Filed: Jan. 29, 2024

Related U.S. Application Data
(63) Continuation-in-part of application No. 16/786,680, filed on Feb. 10, 2020, now Pat. No. 11,883,974.
(60) Provisional application No. 62/823,239, filed on Mar. 25, 2019.
(60) Provisional application No. 62/803,824, filed on Feb. 11, 2019.

(51) Int. Cl. B65G 47/91; B25J 9/00; B25J 11/00; B26D 5/00; B65G 43/00

(52) U.S. Cl. CPC B65G 47/917; B25J 9/0093; B25J 11/0045; B26D 5/007; B65G 43/00; B65G 2201/0202

(57) ABSTRACT

A conveyor system 24, 24E, 24F carries work items, such as flexible, pliable, food products 22, through a scanning system 28 which generates data pertaining to various physical parameters of the food products. Thereafter, the food products are transported through a processing station which may be in the form of a portioning system 30. Next, the portioned food products are transported to a harvesting system 32-32F utilizing an actuator 34-34F to unload the food product portions 36 by vacuuming the portions into at least one nozzle 90, 90E, 90F. Such food products are transported to one or more desired locations through a hose/tube connected to a nozzle or may be launched through the air in a trajectory aimed at the desired placement location.

### CROSS-REFERENCES TO RELATED APPLICATIONS

This application is a continuation-in-part of U.S. patent application Ser. No. 16/786,680, filed Feb. 10, 2020, which claims the benefit of U.S. Provisional Application No. 62/823,239, filed Mar. 25, 2019, and the benefit of U.S. Provisional Application No. 62/803,824, filed Feb. 11, 2019, all of which applications are incorporated by reference herein in their entirety.

### BACKGROUND

In the past, food products, such as raw meat, fish, or poultry, that have been processed, for example, by cutting or portioning, have been manually harvested from moving conveyor belts. However, in manual harvesting, personnel often missed good portions, resulting in such portions becoming trim with the rest of the trim that remains on the belt after harvesting. Further, personnel may harvest trim rather than the actual good portions. Additionally, food products are often cut or portioned to more than one size per piece of raw material. However, manual harvesters often are not able to distinguish between different size or different weight pieces. In addition, the working conditions in food processing plants are not ideal. Typically the temperature at a trim or portioning station may be no more than 40° F. As a result, high turnover of personnel is not uncommon.

To overcome the disadvantages of manual harvesting, automatic harvesting devices have been developed. Such devices typically utilize suction cups to lift the portioned workpieces, such as raw, meat, fish, or poultry, from the conveyor belt and then move the workpiece to a takeaway belt or perhaps a storage bin. In such automatic harvesting devices, a finite amount of time is required to pick up the food product off the conveyor belt and the move the product to a delivery location. Once the food product has been delivered, the pickup device must return to the conveyor belt in empty condition. In order to achieve a desired production rate, often multiple harvesting devices are needed thereby adding to both cost and the size of the harvesting station.

A further limitation of existing automatic harvesting devices is that takeaway conveyors or storage receptacles must be within reach of the harvesting device. This can result in a cumbersome situation, especially if the takeaway conveyors are higher in elevation than the production conveyor belt thereby requiring that the harvesting device be movable in the vertical direction. This can necessitate a more complicated and expensive and slower harvesting device than often is desirable.

Also, in these situations, where the takeaway conveyor must be placed within the reach of the harvesting device, the configuration of processing lines may be limited so that the takeaway conveyor can be close enough to the harvesting conveyor for automatic harvesting to be feasible. Larger harvesting robots can be utilized, but at a significant cost.

Moreover, using suction cups to pick up food products becomes more difficult the faster the food product must be moved. A high vacuum level need be generated to assist in gripping of the food product with the suction cups. However, marks may be left on the products from the suction cups and also more time and energy is required to generate the necessary vacuum level to operate the suction cups, especially for larger food products. Further, if high vacuum levels are needed to “grip” the food product, the likelihood of dropping the food product increases since even a small air leak past the product may cause insufficient gripping of the food product.

The present disclosure seeks to address the foregoing limitations of existing automatic harvesting systems.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with an embodiment of the present disclosure, a food processing system for processing food or work items that may be of variable size and shape, as the food or work items are being carried on a support surface of a conveyor, and removing the processed food or work items from the conveyor to deliver the food or work items to one or more desired locations, comprising:
(a) a scanning system for scanning the food or work items and generating data pertaining to the physical specifications of the food or work items including the size and shapes of the food or work items and the locations of the food or work items on the conveyor;
(b) a removal system for removing the food or work items from the conveyor to deliver the food or work items at a one or more desired locations, comprising:
a first nozzle having an inlet opening shaped and sized to correspond to the shapes and sizes of the food or work items for receiving the food or work items into the first nozzle;
a delivery subsystem in fluid receiving communication with the first nozzle for receiving the food or work items from the first nozzle and directing the food or work items in a desired direction or to a desired location;
a vacuum generator generating a vacuum at the nozzle inlet opening; and
an actuator to move and position the nozzle to desired positions relative to the food or work items; and
(c) a control system receiving data from the scanning system including pertaining to the size and shape of the food or work items, and the location of the food or work items on the conveyor and controlling the actuator to position the nozzle with respect to the food or work item to enable the nozzle to pick up the food or work item, controlling the delivery subsystem to enable the delivery subsystem to deliver the food or work item at one or more desired locations; and controlling the operation of the vacuum generator.

In any of the embodiments described herein, further comprising:
a food processing station located upstream from the removal system to process the food or work items being carried by the conveyor; and
wherein the control system receiving data from the scanning system pertaining to the physical specifications of the food or work items germane to the processing of the food or work items at the food processing station and controlling the processing of the food or work items at the food processing station.

In any of the embodiments described herein, wherein the food processing station comprises a cutting system for cutting one or more portions from the food or work items; and
the control system directing the cutting system to perform the required cuts of the food or work items.

In any of the embodiments described herein, wherein the delivery subsystem comprises a tubular member in fluid communication with the first nozzle, the tubular member having an outlet directed at or directable to a desired direction or to a desired location for delivery of the food or work items.

In accordance with an embodiment of the present disclosure, a harvester for a food processing system wherein variably sized and shaped food or work items being processed are carried on a conveyor, the food processing system including a scanning system for scanning the food or work items to generate data pertaining to the physical specifications of the food or work items, including the size and shape of the food or work items and the locations of the food or work items on the conveyor, the harvester removing the processed food or work items from the conveyor and delivering the removed food or work items at one or more desired locations, the harvester comprising:
(a) a pickup system for picking up the food or work items from the conveyor, comprising:
a nozzle having an inlet configuration based on the size and shape of the food or work items;
a discharge subsystem in flow communication with the nozzle; and
a vacuum source for creating a vacuum at the nozzle;
(b) an actuator to optimally position the nozzle in desired position relative to the food or work items to facilitate picking up the food or work items with the nozzle; and
(c) a control system for receiving data from the scanning system pertaining to the physical specifications of the food or work items, including the size and shape of the food or work items and the locations of the food or work items on the conveyor, and controlling the actuator to position the nozzle with respect to the food or work items to enable the nozzle to pick up the food or work item from the conveyor and controlling the discharge subsystem to place the food or work items at one or more desired locations.

In accordance with an embodiment of the present disclosure, a system for cutting portions from a variably sized and shaped and food or work items based on desired physical specifications of the cut portions and placing the cut portions at one or more desired locations, comprising:
(a) a conveyor system for conveying the food or work items;
(b) a scanning system for scanning the food or work items and generating data pertaining to physical specifications of the food or work items including the size and shape of the food or work items and the locations of the food or work items on the conveyor;
(c) a cutting system for cutting one or more portions from the food or work items;
(d) a pickup system for picking up the cut portions from the conveyor, comprising:
a nozzle having an inlet configured based on the size and shape of the cut food or work items;
a discharge subsystem in flow communication with the nozzle; and
a vacuum source generating a vacuum at the nozzle inlet;
(e) an actuator coupled to the nozzle to optimally place the nozzle in optimum position relative to the cut piece to facilitate picking up the cut piece with the nozzle; and
(f) a control system:
processing the scanned data to determine the physical characteristics of the food or work item including the size and shape of the food or work items and the locations of the food or work items on the conveyor;
determining the cutting paths to cut the food or work items to achieve desired physical specifications of the cut portions;
directing the cutting system to perform the determined cuts;
directing the actuator to position the nozzle with respect to the food or work items to enable the nozzle to optimally pick up the cut portions; and
controlling the discharge subsystem to deliver the cut food or work items at one or more desired locations.

In accordance with an embodiment of the present disclosure, a harvester for harvesting work items being processed are carried on a conveyor, the harvester removing the work items from the conveyor and delivering the removed work items at one or more desired locations, the harvester comprising:
(a) a pickup system for picking up the work items from the conveyor, comprising:
a nozzle having an inlet configuration based on the size and shape of the food or work items;
a ballistic launcher in flow communication with the nozzle to launch the work items into the air at a trajectory to deliver the work items to one or more delivery locations; and
a vacuum source for creating a vacuum at the nozzle sufficient to cause the work items to enter the nozzle and be launched from the ballistic launcher;
(b) an actuator to optimally position the nozzle in desired position relative to the work items to facilitate picking up the work items with the nozzle; and
(c) a control system controlling the actuator to position the nozzle with respect to the work items to facilitating the nozzle picking up the work item from the conveyor and controlling the ballistic launcher to deliver the work items at one or more desired locations.

In any of the embodiments described herein, wherein the discharge subsystem comprises a tubular member in fluid communication with the nozzle, the tubular member having an outlet directed at or directable to a desired direction or to a desired location for delivery of the food or work items.

In any of the embodiments described herein, further comprising an actuator acting on the outlet of the tubular member to direct the outlet at a desired direction or to a desired location for the delivery of the food or work items.

In any of the embodiments described herein, wherein the control system controlling the actuator acting on the outlet of the tubular member to direct the outlet at a desired direction or to a desired location for the delivery of the food or work items.

In any of the embodiments described herein, further comprising a vacuum generator positioned along the length of the tubular member to generate a vacuum upstream of the location of the vacuum generator and generate a positive pressure in the tubular member downstream of the location of the vacuum generator.

In any of the embodiments described herein, further comprising one or more pressure sensors operably connected to the tubular member to sense the pressure at one or more locations along the length of the tubular member.

In any of the embodiments described herein, wherein the tubular member comprises a member or a combination of members selected from the group consisting of: a rigid tube, a flexible tube, a hose, and a flexible hose.

In any of the embodiments described herein, wherein the delivery subsystem comprises a ballistic launcher in flow communication with the first nozzle to launch food or work items into the air at a trajectory to deliver the food or work items to one or more delivery locations.

In any of the embodiments described herein, wherein the pickup system comprises a ballistic launcher in flow communication with the nozzle to launch food or work items into the air at a trajectory to delivery of the food or work items to one or more delivery locations.

In any of the embodiments described herein, wherein the control system controlling the trajectory of the food or work item launched from the ballistic launcher.

In any of the embodiments described herein, further comprising a plurality of nozzles having inlet shapes and sizes to correspond to food or work items of different shapes and sizes, the plurality of nozzles detachably attachable to the actuator.

In any of the embodiments described herein, wherein the actuator operable by the control system to select a specific nozzle appropriate for the size and shape of the food or work items being processed.

In any of the embodiments described herein, wherein the control system controlling the vacuum generator to produce a vacuum at the first nozzle at a desired level and for a desired duration.

In any of the embodiments described herein, wherein the control system controlling the vacuum generator to produce a vacuum at the nozzle at a desired vacuum or air flow level and for a desired duration.

In any of the embodiments described herein, wherein the control system controlling the vacuum generator to pause the operation of the vacuum generator between sequential food or work items being picked up by the nozzle if sufficient time exists between the picking up of sequential food or work items.

In any of the embodiments described herein, wherein the inlet of the first nozzle resembles the shape of the food or work item when the nozzle is in a specific orientation relative to the food or work item.

In any of the embodiments described herein, wherein the shape of the nozzle inlet is generalized so that in at least two orientations of the first nozzle, the shape of the nozzle resembles the shape of the food or work item.

In any of the embodiments described herein, wherein the size and/or shape of the nozzle inlet is selected to be the same or smaller than the size and shape of food or work items to be received into nozzle.

In any of the embodiments described herein, wherein the size and/or shape of the nozzle inlet is selected so that the entire area, or substantially the entire area, of the nozzle inlet is covered of the food or work items to be received into nozzle.

In any of the embodiments described herein, wherein the size and/or shape of the nozzle inlet is selected so that at least 90 percent of the entire area of the nozzle inlet is covered of the food or work items to be received into the first nozzle.

In any of the embodiments described herein, wherein the size and/or shape of the nozzle inlet is selected so that at least 80 percent of the entire area of the nozzle inlet is covered of the food or work items to be received into the first nozzle.

In any of the embodiments described herein, wherein the size and/or shape of the nozzle inlet is selected so that at least 70 percent of the entire area of the nozzle inlet is covered of the food or work items to be received into the first nozzle.

In any of the embodiments described herein, wherein the nozzle comprises a plurality of inlet opening and the actuator indexes the nozzle so that a desired inlet opening is presented to the food or work item being removed.

In any of the embodiments described herein, further comprising pressure sensors operably associated with the first nozzle to sense the pressure within the first nozzle.

In any of the embodiments described herein, wherein a rim extends around at least a portion of the first nozzle inlet to project from the nozzle inlet, the rim having a thickness that reduces in the direction away from the nozzle inlet.

In any of the embodiments described herein, wherein a rim extends around at least a portion of the first nozzle inlet to project from the nozzle inlet, the rim being resiliently flexible so as to at least partially conform to the contour of the top surface of the food or work items.

In any of the embodiments described herein, wherein:
the conveyor defines a generally planar moving support surface; and
the control system controls the actuator to rotate the first nozzle about an axis normal to the conveyor support surface.

In any of the embodiments described herein, wherein the control system controls the actuator to also rotate the first nozzle about two perpendicular axes that are disposed parallel to the support surface of the conveyor.

In any of the embodiments described herein, wherein:
the removal system comprising:
a plurality of nozzles of different sizes or shapes;
an actuator for each nozzle; and
the control system controlling the actuators to pick up food or work items corresponding to the size and/or shape of the nozzle attached to the actuator.

In any of the embodiments described herein, wherein:
the pickup system comprising:
a plurality of nozzles of different sizes or shapes;
an actuator for each nozzle; and
the control system controlling the actuators to pick up food or work items corresponding to the size and/or shape of the nozzle attached to the actuator.

In any of the embodiments described herein, further comprising a skirt extending at least partially around the inlet of the nozzles to extend outwardly of the perimeter of the first nozzle.

In any of the embodiments described herein, wherein the skirt being resiliently flexible to apply a downward load on the food or work item located beneath the skirt and at least partially conforming to the topography of the top surface of the food or work item.

In any of the embodiments described herein, wherein the control system controls the actuator to position the nozzles with respect to the food or work item based on seeking to position the nozzle inlet so that the entire area of the nozzle inlet, or as much of the area of the nozzle inlet as possible, is within the perimeter of the food or work items, and so that the center of the nozzle coincides or nearly coincides with the centroid of the food or work item.

In any of the embodiments described herein, wherein the actuator is a robotic actuator having at least four degrees of movement.

In any of the embodiments described herein, wherein the actuator is capable of moving the nozzle in one or more directions selected from the group consisting of: rotatable about an upright axis relative to the support surface of the conveyor; in an upright direction transverse to the support surface of the conveyor; in a direction transverse to the longitudinal direction of travel of the conveyor; and in a direction along the directional travel of the conveyor.

In any of the embodiments described herein, wherein the actuator comprises a delta robot having degrees of freedom of movement selected from the group consisting of three degrees of freedom of movement, four degrees of freedom of movement, and six degrees of freedom of movement.

In accordance with one embodiment of the present disclosure, a harvester is provided for a food processing system wherein variably sized and shaped food items being processed are carried on a moving surface, the food processing system including a scanning system for scanning the food items to generate data pertaining to the physical specifications of the food items, the harvester removing the food items from the moving surface and delivering the removed food items at one or more desired locations. The harvester includes: (a) a pickup system for picking up the food items from the moving surface, comprising a plurality of nozzles having an inlet configuration based on the food items being receivable into the nozzles, a discharge subsystem in flow communication with the nozzles, and a vacuum source for creating a vacuum at the nozzles; (b) a first actuator to optimally place the nozzles in desired position relative to the food items to facilitate picking up the food items with the nozzles; and (c) a control system for receiving data from the scanning system pertaining to the physical specifications of the food items and the locations of the food items on the moving surface, and controlling the first actuator to position the nozzles with respect to the food items to enable the nozzles to pick up the food items from the moving surface and controlling the discharge subsystem to place the food items at one or more desired locations.

In any of the embodiments described herein, wherein the first actuator indexes the nozzles so that the inlet opening of a desired nozzle is presented to the food item harvested in a desired manner.

In any of the embodiments described herein, wherein the plurality of nozzles having inlet shapes and sizes to correspond to food items of different shapes and sizes, the plurality of nozzles detachably attachable to the actuator.

In any of the embodiments described herein, wherein the inlets of the nozzles are characterized by one or more of the following: the shape of the nozzle inlets resemble the shape of the food items when the nozzle is in a specific orientation relative to the food items; the shape of the nozzle inlets are generalized so that in at least two orientations of the nozzles, the shapes of the nozzles resemble the shapes of the food items; the sizes and/or shapes of the nozzle inlets are selected to be the same or smaller than the sizes and shapes of food items to be received into the nozzles; and the sizes and shapes of the nozzle inlets are selected so that the entire area, or substantially the entire area, of the nozzle inlets is covered by the food items to be received into the nozzles.

In any of the embodiments described herein, wherein the plurality of nozzles are disposed side-by-side to each other.

In any of the embodiments described herein, wherein the first actuator positions the nozzles to align a nozzle with a desired food item to be harvested, while avoiding the other nozzle(s) from disturbing a food item or food trim.

In any of the embodiments described herein, wherein the pickup system comprises a ballistic launcher in flow communication with the nozzles to launch food items into the air at a trajectory to delivery of the food items to one or more delivery locations.

In any of the embodiments described herein, wherein the nozzles are disposed side-by-side to each other.

In any of the embodiments described herein, wherein the ballistic launcher launches the food items from the nozzles in opposite directions.

In any of the embodiments described herein, wherein the control system controls the trajectories of the food items launched from the ballistic launchers.

In any of the embodiments described herein, further comprising at least one removal conveyor located adjacent to the moving surface, and the control system controlling the trajectories of the food items launched from the ballistic launchers to place the food items on the at least one removal conveyor.

In any of the embodiments described herein, further comprising a back stop shaped to receive the food items launched from the ballistic launchers and direct the food items onto the at least one removal conveyor.

In any of the embodiments described herein, wherein the control system controlling the trajectories of the food items to place the food items at desired spaced apart locations on the at least one removal conveyor.

In any of the embodiments described herein, wherein the actuator is capable of moving the nozzle in one or more directions selected from the group consisting of rotatable about an upright axis relative to the moving surface, rotatable about an axis extending parallel to the moving surface, in an upright direction transverse to the moving surface, in a direction transverse to the direction of travel of the moving surface, and in a direction along the directional travel of the moving surface.

In any of the embodiments described herein, wherein the discharge subsystem comprises a tubular member in fluid communication with the nozzles, the tubular member having an outlet directed at, or directable to, a desired direction or to a desired location for delivery of the food items.

In any of the embodiments described herein, further comprising a second actuator acting on the outlet of the tubular member to direct the outlet at a desired direction or to a desired location for the delivery of the food items.

In any of the embodiments described herein, wherein the control system controls the actuator to position the nozzles with respect to the food items based on seeking to position the nozzle inlets so that the entire area of the nozzle inlets, or as much of the area of the nozzle inlets as possible, are within the perimeter of the food items, and so that the center of the nozzles coincide or nearly coincide with the centroids of the food items.

In accordance with one embodiment of the present disclosure, a food processing system is provided for processing food items. The food processing system includes: (a) a scanning system for scanning the food items on a moving surface and generating data pertaining to the physical specifications of the food items and the locations of the food items on the moving surface; and (b) the harvester in accordance with any of the embodiments herein for harvesting the food items on the moving surface.

In any of the embodiments described herein, further comprising a food processing station located upstream from the harvester to process the food items being carried by the moving surface, and wherein the control system receiving data from the scanning system pertaining to the physical specifications of the food items germane to the processing of the food items at the food processing station and controlling the processing of the food items at the food processing station.

In any of the embodiments described herein, wherein the food processing station comprises a cutting system for cutting one or more portions from the food items, and the control system directing the cutting system to perform the required cuts of the food items.

In any of the embodiments described herein, wherein the physical specifications include at least one of the size and shape of the food items.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an isometric view, partially in schematic, illustrating an overall system of the present disclosure;

FIG. 2 is an enlarged fragmentary isometric view of FIG. 1 focusing on the harvesting system of the present disclosure;

FIG. 3 is a side elevational view of FIG. 2;

FIG. 4 is a plan view of FIGS. 2 and 3 illustrating portioned food products removed to a takeaway conveyor;

FIG. 5 is a view similar to FIG. 4 wherein the portioned food products are placed in storage bins;

FIG. 6 is a view similar to FIG. 3 wherein the food products are launched through the air to be placed on various takeaway conveyors;

FIG. 7 is a view similar to FIG. 6 wherein the food products are launched through the air to be placed in storage bins;

FIG. 8 is a plan view of FIG. 7;

FIGS. 9A-9H illustrate an example of a suction nozzle of the present disclosure;

FIG. 10 illustrates the shape of an opening of the suction nozzle;

FIGS. 11A-11C illustrate how the design of a suction nozzle is determined;

FIGS. 12A and 12B show another example how the shape of a suction nozzle is determined;

FIGS. 13A and 13B illustrate further example of the suction nozzle of the present disclosure;

FIG. 14 illustrates another example of the suction nozzle of the present disclosure;

FIG. 15 illustrates further embodiments of the present disclosure;

FIG. 16 illustrates further embodiments of the present disclosure;

FIG. 17 illustrates further embodiments of the present disclosure;

FIG. 18 discloses a further embodiment of the present disclosure;

FIG. 19 is an isometric view of a further embodiment of the present disclosure;

FIG. 20 is an isometric view of the embodiment of the present disclosure shown in FIG. 19, taken from the opposite side of the embodiment from FIG. 19;

FIG. 21 is an enlarged view of a portion of FIG. 19;

FIG. 22 is a view similar to FIG. 21, taken from the opposite side of the actuator;

FIG. 23 is an isometric view of a further embodiment of the present disclosure;

FIG. 24 is an enlarged view of a portion of FIG. 23 and taken from a substantially overhead view;

FIG. 25 is an enlarged view of the embodiment of FIG. 23, taken from the opposite side of the embodiment and from a side elevation;

FIG. 26 is an enlarged view of the embodiment of FIG. 23, taken from an end elevation;

FIG. 27 is an enlarged isometric view of a portion of the actuator and nozzle assembly of FIGS. 19-22 directed in the downward direction;

FIG. 28 is an enlarged isometric view similar to FIG. 27 but directed in the upward direction;

FIG. 29 is an enlarged isometric view of a portion of the actuator and nozzle assembly of FIGS. 23-26 directed in the downward direction; and

FIG. 30 is an enlarged isometric view similar to FIG. 29 but directed in the upward direction.

### DETAILED DESCRIPTION

The description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. Further, it will be appreciated that embodiments of the present disclosure may employ any combination of features described herein.

The present application may include references to “directions,” such as “forward,” “rearward,” “front,” “back,” “ahead,” “behind,” “upward,” “downward,” “above,” “below,” “top,” “bottom,” “right hand,” “left hand,” “in,” “out,” “extended,” “advanced,” “retracted,” “proximal,” and “distal.” These references and other similar references in the present application are only to assist in helping describe and understand the present disclosure and are not intended to limit the present invention to these directions.

The present application may include modifiers such as the words “generally,” “approximately,” “about”, or “substantially.” These terms are meant to serve as modifiers to indicate that the “dimension,” “shape,” “temperature,” “time,” or other physical parameter in question need not be exact, but may vary as long as the function that is required to be performed can be carried out. For example, in the phrase “generally circular in shape,” the shape need not be exactly circular as long as the required function of the structure in question can be carried out.

In the following description, various embodiments of the present disclosure are described. In the following description and in the accompanying drawings, the corresponding systems assemblies, apparatus and units may be identified by the same part number, but with an alpha suffix. The descriptions of the parts/components of such systems assemblies, apparatus, and units that are the same or similar are not repeated so as to avoid redundancy in the present application.

In the present application and claims, references to “food,” “food products,” “food pieces,” and “food items,” are used interchangeably and are meant to include all manner of foods. Such foods may include meat, fish, shellfish, poultry, fruits, vegetables, nuts, or other types of foods. Also, the present systems and methods are directed to raw food products, as well as partially and/or fully processed or cooked food products.

Further, the system, apparatus and methods disclosed in the present application and defined in the present claims, though specifically applicable to food products or food items, may also be used outside of the food area. Accordingly, the present application and claims reference “work products,” “work items” and “workpieces,” which terms are synonymous with each other. It is to be understood that references to work products and workpieces also include food, food products, food pieces, and food items.

The system and method of the present disclosure include the automatic scanning of workpieces, including food items, to ascertain physical parameters of the workpiece comprising the size and/or shape of the workpiece. Such size and/or shape parameters may include, among other parameters, the length, width, aspect ratio, thickness, thickness profile, contour, outer contour, outer perimeter, outer perimeter configuration, outer perimeter size, outer perimeter shape, volume and/or weight of the workpiece. With respect to the physical parameters of the length, width, length/width aspect ratio, and thickness of the workpieces, including food items, such physical parameters may include the maximum, average, mean, and/or medium values of such parameters. With respect to the thickness profile of the workpiece, such profile can be along the length of the workpiece, across the width of the workpiece, as well as both across/along the width and length of the workpiece.

As noted above, a further parameter of the workpiece that may be ascertained, measured, analyzed, etc., is the contour of the workpiece. The term contour may refer to the outline, shape, and/or form of the workpiece, whether at the base or bottom of the workpiece or at any height along the thickness of the workpiece. The parameter term “outer contour” may refer to the outline, shape, form, etc., of the workpiece along its outermost boundary or edge.

The parameter referred to as the “perimeter” of the workpiece refers to the boundary or distance around a workpiece. Thus, the terms outer perimeter, outer perimeter configuration, outer perimeter size, and outer perimeter shape pertain to the distance around, the configuration, the size and the shape of the outermost boundary or edge of the workpiece.

The foregoing enumerated size and/or shape parameters are not intended to be limiting or inclusive. Other size and/or shape parameters may be ascertained, monitored, measured, etc., by the present system and method. Moreover, the definitions or explanations of the above specific size and/or shape parameters discussed above are not meant to be limiting or inclusive.

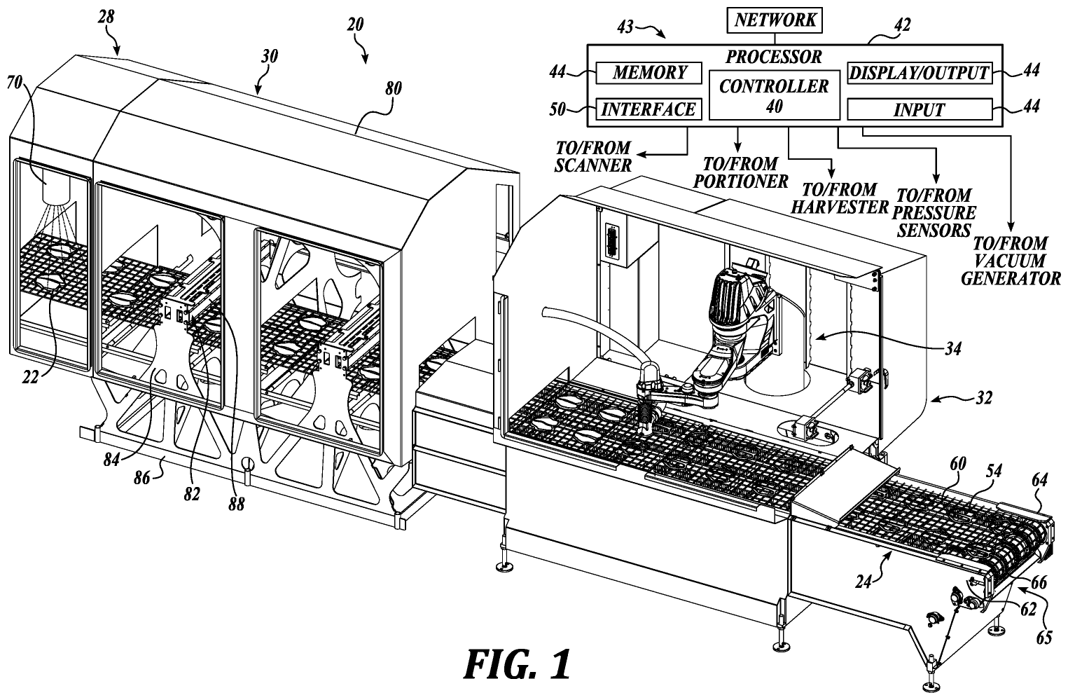

FIG. 1 schematically illustrates a system 20 implementing an embodiment of the present disclosure wherein food products 22 are harvested (also interchangeably referred to a “picking”) after processing. The system 20 includes a moving support surface in the form of a conveyor system 24 for conveying the food products in multiple lanes of windrows, extending along the conveyance system to be portioned, trimmed, cut, or processed in other ways. The conveyance system 24 initially carries the food products 22 through a scanning system 28 for scanning the food products and generates data pertaining to various physical parameters of the food products as discussed above. Thereafter, the food products 22 are transported through a processing system, which in FIG. 1 is illustrated as being in the form of a cutting/trimming/portioning system 30 (hereinafter for convenience simply referred to as portioning system 30). Next, the portioned food products 22 are transported to a harvesting system 32 whereas a robotic actuator 34 operates to unload the food product portions 36 by vacuuming into a nozzle and then transporting food product portions through a hose or tube or launching the food portions through the air, thereby placing such food portions at one or more desired locations, which, for example, may be in the form of one or more takeaway conveyors and/or one or more product receiving receptacles or bins.

The conveyor system 24, the scanning system 28, the portioning system 30, the harvesting system 32, including the robotic actuator 34 are coupled to and controlled by a controller 40 operated by a processor 42 of a processing system 43, as schematically shown in FIG. 1. The processing system 43 includes an input device 44 (keyboard, mouse, touchpad, etc.) and an output device 46 (monitor, printer). The processing system 43 also includes a memory unit 48 and an interface 50 for receiving signals and information from the conveyor system 24, scanning system 28, portioning system 30, harvesting system 32 including robotic actuator 34 as well as from other data sources of system 20, as described more fully below. The processor 42 may be connected to a network 52. Also, rather than employing a local processor 42, a network computing system can be used for this purpose.

Generally, the scanning system 28 includes a scanner for scanning the food products 22 to produce data relating to or representative of the physical specifications of the food product 22, and forwards this data to the processor 42. The processor, using a scanning program, analyzes the scanning data to determine the location of the food products 22 on the conveyance system and develops physical parameters of the scanned food products, in including for example, a length, width, area, and/or volume distribution of the scanned food product. The processor may also develop a thickness profile of the scanned food products as well as the overall shape and size of the food products. The processor 42 can then model the food products to determine how the food products may be divided, trimmed, and/or cut into end pieces or portions 36 composed of specific physical criteria, including, for example, shape, area, weight and/or thickness. In this regard, the processor 42 may take into consideration that the thickness of the food products 22 may be altered either before or after the work products are cut at the portioning station 30 by a slicer, not shown. The processor 42, using the scanning program and/or portioning program, determines how the food products may be portioned into one or more end products 36 or end product sets. The controller 40 then functions to control the cutter system 30 to portion the food products 22 according to desired end product pieces 36 and then the controller controls the harvesting of the portioned food pieces 36 from the conveyor system and the placing of the portioned food pieces 36 at one or more desired locations either away from the conveying system 24 or back onto the conveying system after the trim 54 has been removed.

Next, describing the system 20 in more detail, the conveyance system 24 includes a moving belt 60 that slides over an underlying support or bed 62. The belt 60 is driven by drive rollers (not shown) mounted on a frame structure 64 that also carries a conveyor belt bed 62. The drive rollers are in turn driven at a selected speed by a drive motor (not shown) in a standard manner. The drive motor can be composed of a variable speed motor to thus adjust the speed of the belt as desired as the food products are carried past the scanning system 28, the portioning system 30, and the harvesting system 32. At the outlet end 65 of the conveyor system 24, the belt 60 trains around idler rollers 66 mounted on the frame structure 64 in a standard manner.

An encoder, not shown, is integrated into the conveyance system 24, for example, at the drive rollers to generate electrical pulses at fixed distance intervals corresponding to the forward movement of the conveyor belt 60. This information is routed to the processor 42 so that the location(s) of the food products 22, or the portions 36 cut from the food products, can be determined and monitored as the food products or portions travel along the conveyor system 24. This information can be used to position cutters of the portioning system 30 as well as the components of the harvesting system 32, including the robotic actuator 34.

The scanning system 28 can be of various configurations or types, including a video camera (not shown) to view the food products illuminated by one or more light sources 70. Light from the light sources 70 is extended across the moving conveyor belt 60 to define a sharp shadow or light stripe line, with the area forwardly of the transverse beam being dark. When no food product 22 is being carried by the conveyor belt 60, the shadow of the light stripe forms a straight line across the conveyor belt. However, when the food product 22 passes across the shadow line/light stripe, the upper, irregular surface of the food product produces an irregular shadow line/light stripe as viewed by the video camera angled downwardly on the food product and the shadow light/light stripe. The video camera directs the displacement of the shadow line/light stripe from the position it would occupy if no food product were present on the conveyor belt 60. This displacement represents the thickness of the food product along the shadow line/light stripe. The length of the food product is determined by the distance of the belt travel that the shadow line/light stripes are created by the food product. In this regard, the encoder, which is integrated into the conveyance system, generates pulses at fixed distance intervals corresponding to the forward movement of the conveyor belt 60.

In lieu of a video camera, the scanning system 28 may instead utilize an X-ray apparatus (not shown) for determining the physical characteristics of the food product 22, including its shape, mass and weight. X-rays may be passed through the object in the direction of an X-ray detector (not shown). Such X-rays are attenuated by the food product in proportion to the mass thereof. The X-ray detector is capable of measuring the intensity of the X-rays received by the detector, after passing through the food product. This attenuation is utilized to determine the overall shape and size of the food product 22 as well as its mass. An example of such an X-ray scanning device is disclosed in U.S. Pat. No. 5,585,605, incorporated by reference herein.

The foregoing scanning systems are known in the art, and thus are not novel per se. However, use of these scanning systems in conjunction with other aspects of the described embodiments is believed to be new.

The data and information measured/gathered at the scanning system 28 is transmitted to the processor 42 which records and/or notes the location of the food products on the conveyor 24 as well as data pertaining to physical parameters of the food products as discussed above. With this information, the processor, operating, for example, under the scanning system software, can develop an area profile as well as a volume profile of the food products. Knowing the density of the food products, the processor can also determine the weight of the food products or segments or sections or portions thereof.

Although the foregoing description discusses scanning by use of a video camera and a light source as well as by use of X-rays, other three-dimensional scanning techniques may be utilized. For example, such additional techniques may be by ultrasound or mire fringe methods. In addition, electromagnetic imaging techniques may be employed. Thus, the present invention is not limited to the use of video cameras or X-ray methods but encompasses other three-dimensional scanning technologies.

In system 20, the food products 22 can be processed in various ways. One example is illustrated in FIG. 1 wherein the food products are processed by the cutting/trimming and/or portioning thereof at portioning system 30. The conveying system 24 carries the food products 22 through the portioning system 30 whereat the food products are cut or trimmed or portioned into desired end pieces 36.

The portioning station includes a housing 80 to enclose cutting units 82, which are mounted above the conveyor 24 by frame systems 84 that extend upwardly from a base 86 to support the ends of the cutter units 82 which span across the conveyor belt 60. The cutting units can be of various types, including in the form of high pressure liquid nozzle assemblies, not shown, which are mounted on carriers or carriages which move across the conveyor belt on a transverse support system 88. The carriers may also be moveable along the length of the conveyor belt. Examples of such support systems are disclosed by U.S. Pat. No. 9,778,651, incorporated herein by reference, as well as U.S. Pat. No. 6,826,989, also incorporated herein by reference.

It is to be understood that the system 20 may include other types of food processing systems, including a slicing apparatus to slice food products to desired thicknesses, a flattening apparatus to flatten food products to a desired thickness, a thermal processing system to heat or cool the food product, etc. Once the processing of the food product occurs, the harvesting system 32 is used to harvest the food products 22 or portions thereof 36 thereby to place the food products or portions thereof at one or more desired locations. In the system 20 illustrated in the figures of the present application, the food products 22 are shown as portioned into a plurality of pieces 36 at the portioning system 30. A certain amount of trim 54 typically results from the cutting/portioning of the food products into desired pieces.

The harvesting system is capable of separating the cut pieces 36 from the trim 54 and then transporting the cut pieces to one or more desired locations. Moreover, the harvesting system 32 is able to carry out this function more quickly and efficiently in that existing devices that must first picking up the food pieces from a conveyor and then traveling to the delivery destination of the food pieces, as in standard “pick-and-place” system. In standard systems, the mechanism for picking the food product must then physically transfer the food product to a desired drop off location and then travel back to the conveyor to pick up the next food product piece.

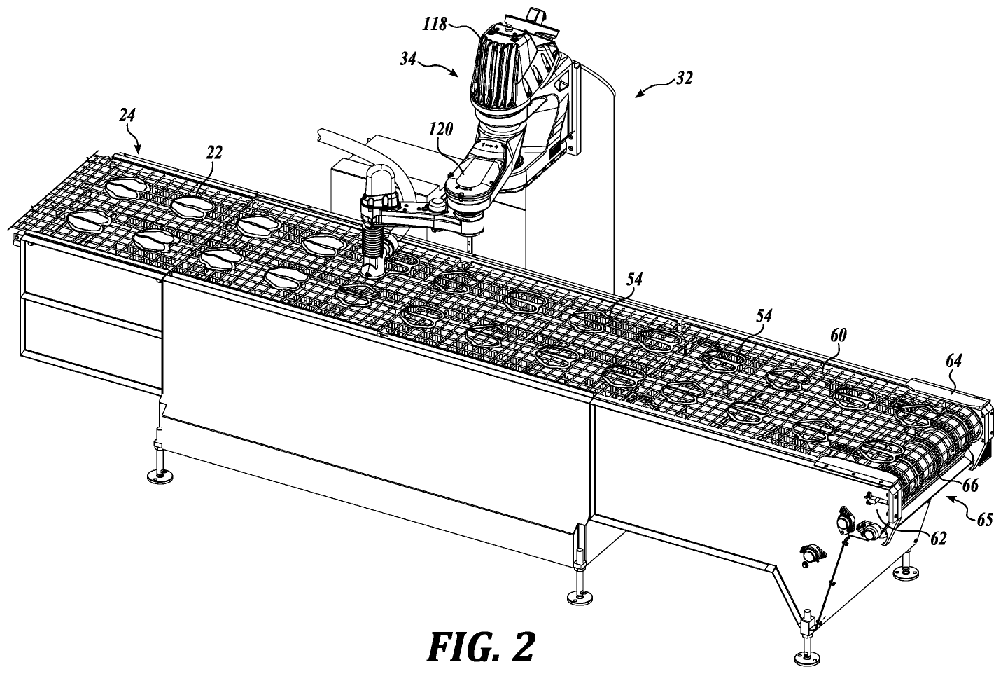

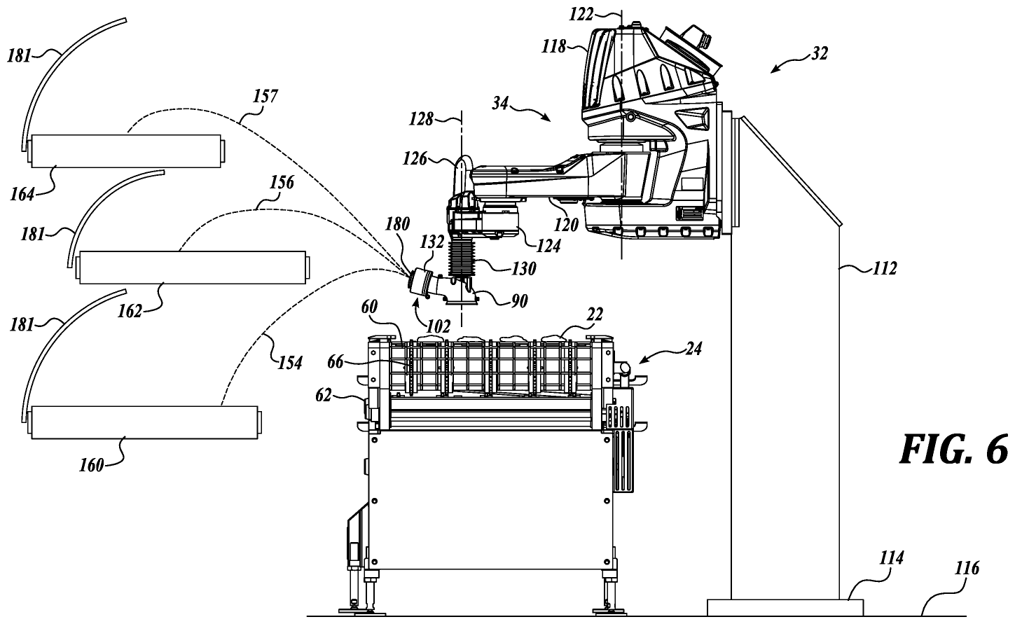

As shown in the figures, harvesting system 32 basically includes multi-axis robotic actuator 34 which carries and manipulates a vacuum nozzle 90 which is designed to suck or vacuum up the work product pieces through the nozzle and transmit the work product pieces to a delivery subsystem 92. The delivery subsystem can be of various configurations, including a delivery tube in the form of a rigid, partially rigid or flexible tube or hose 100 shown in FIGS. 1-5 or a ballistic launcher 102 as shown in FIGS. 6-8, as discussed more fully below.

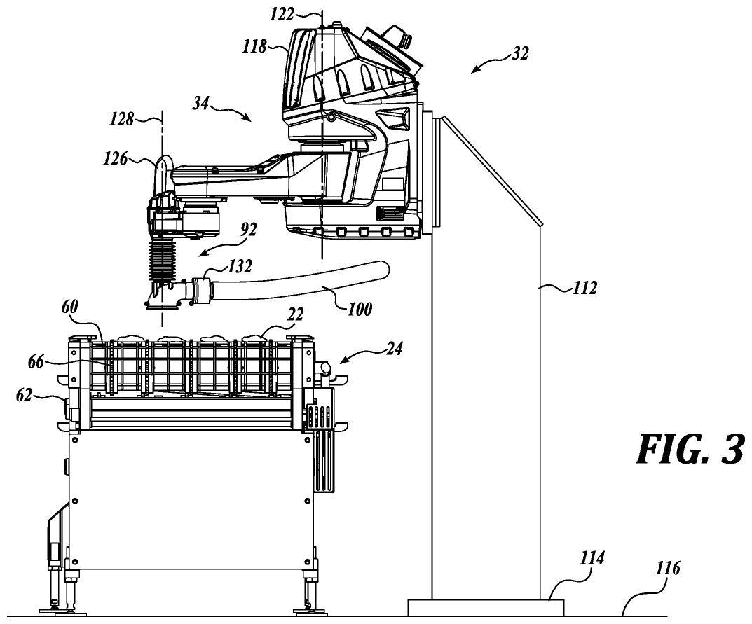

The robotic actuator 34 includes a base unit 110 [show in FIG. 3] mounted on an upright mounting post 112 extending upwardly from a base plate 114 secured to floor 116. The base unit 110 may be operable to move at least vertically relative to the mounting post 112. The base unit 110 includes a motor disposed within an upper housing 118 for rotating an inward arm 120 about a vertical axis 122. The motor disposed within the housing 118 can be of various types, including electrically or pneumatically powered to operate the inward arm 120 at very high speeds.

The robotic actuator 34 also includes an outward arm 124 rotatably coupled to the distal end of the inward arm 120 and rotatable at high speed relative to the inward arm by a rotary actuator, not shown.

An actuating head 126 is rotatably mounted on the distal end of outward arm 124 to rotate about vertical axis 128 also at high speed and also to raise and lower toward and away from the conveyor belt 60. This vertical movement can be accomplished by a telescoping arrangement or by other means protected by an exterior flexible bellows 130. The lower end of the actuating head 126 is mounted to nozzle 90.

Although the robotic actuator 34 is illustrated as having four degrees of freedom, the robotic actuator can be configured with at least six degrees of freedom, including the ability to rotate the actuator head about two axes extending substantially parallel to the horizontal. With this additional movement, the nozzle 90 could be tilted about the horizontal relative to the carrying surface of conveyor belt 60.

FIGS. 1-5 depict the delivery subsystem 92 in the form of a tube or hose 100 having an inlet end in fluid communication with nozzle 90. A vacuum generator 132 is disposed between the nozzle 90 and the inlet of tube/hose 100. The vacuum generator 132 creates a vacuum at the inlet of the nozzle 190 and optionally a positive pressure in the hose/tube 100 downstream of the vacuum generator.

Various types of vacuum generators may be utilized. In one form, the vacuum generator may include an air mover wherein compressed air is blown through an annular space forming a ring around a hose/tube attachment. The air pressure is converted into air flow through the air mover which entrains and moves air into the tube/hose 100. Both the size of the annular space in the air mover and the pressure can be varied to provide different rates of air flow. Such air movers rely on a relatively high rate of air flow to create a suction force at the inlet nozzle 90, rather than a high level of vacuum generated by a vacuum generator. The relatively high rate of air flow helps keep the orifices of the vacuum/air flow generator free from the being plugged by the food product, including fat and debris from the food product.

It is to be understood that a vacuum can be created at the inlet of nozzle 190 so that atmosphere pressure is sufficient to lift the harvested food product items 36 from the conveyor belt 60 and into the nozzle 90 and through the tube/hose 100. As such, air pressure above atmospheric pressure may not be needed in the delivery subsystem 92.

The controller 40 may be utilized to control both the volume of air flow and the pressure of air flow to the air mover and thus control the vacuum level generated at the nozzle 90. Air movers such as that described above are articles of commerce.

Although the air mover/vacuum generator 132 is shown as being at the connection between the nozzle 90 and tube/hose 100, the vacuum generator can instead be located along the length of the hose/tube, or even at or toward the outlet end of the hose/tube.

Further, more than one vacuum generator may be utilized, for instance, a first vacuum generator may be positioned at the connection between the nozzle 90 and the tube/hose 100 and a second vacuum generator positioned downstream along the length of the hose/tube. Use of multiple vacuum generators can increase the rate of transfer of the workpieces through the hose/tube so as to achieve a desired harvesting rate.

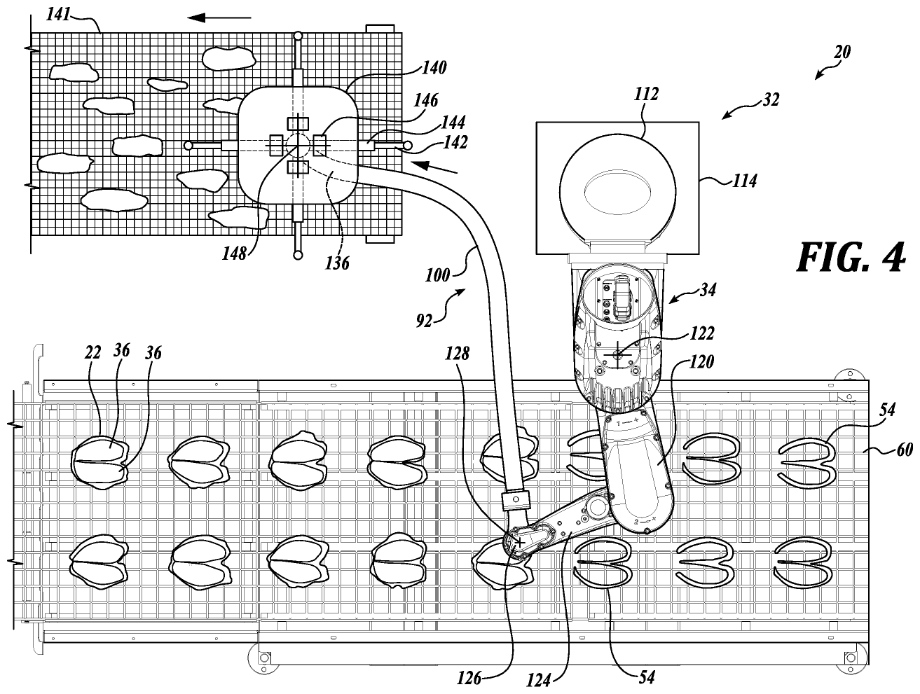

In FIG. 4, the outlet end 136 of the tube/hose is coupled to a delta robot 140 which is mounted above or adjacent a takeaway conveyor 141 to deposit the cut workpieces 36 on the conveyor in various lanes depending on different factors, including one or more physical parameters of the harvested workpieces. For example, harvested workpieces may be positioned in different lanes along the takeaway conveyor 141 depending on weight, size, thickness, length, and/or width, etc. The controller 40 is aware of the parameter or parameters in question from the scanning data and from operation of the portioning system 30. As such, when the robotic actuator 34 picks up the workpiece portion 36 from conveyor belt bed 62, the controller 40 controls the delta robot 140 so that the portion piece 36 in question is positioned in the correct lane of the takeaway conveyor 141.

Delta robots such as robot 140 are articles of commerce. Very briefly, robot 140 is composed of four sets of lower arms 142 that are connected at their upper ends to an upper powered pivot arms 144 which in turn are connected to rotary actuators 146 that are powered to rotate about a horizontal axis. Each of the four pivot arms 144 extends outwardly from a central axis 148 in a quadrant arrangement. The lower or distal ends of the lower extension arms 142 are connected to a carrier head or attachment, not shown, to which the outlet/distal end 136 of the tube/hose 100 is attached.

The delta robot 140 is capable of moving the outlet end 136 of the hose/tube laterally across the conveyor 141, longitudinally along the length of the conveyor 141, as well as vertically relative to the conveyor. The delta robot is also capable of moving the distal end of the hose/tube diagonally relative to the plane of the conveyor surface as well as diagonally relative to the vertical. As such, the delta robot is capable of positioning the harvested workpieces 36 on the conveyor 141 very precisely and quickly so as to keep pace with the operation of the robot actuator 34.

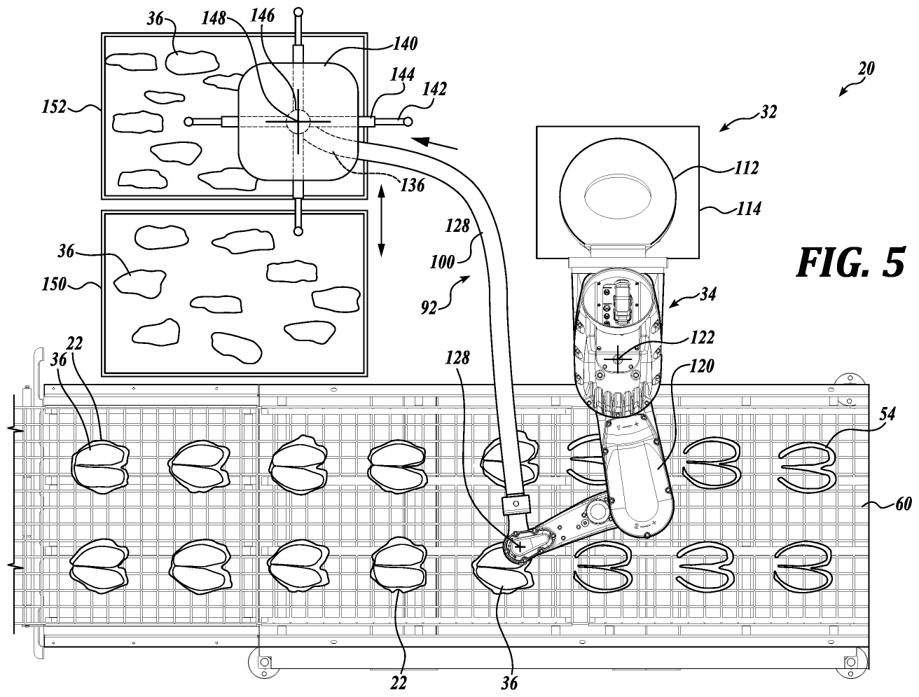

Next, referring to FIG. 5, the hose/tube outlet end 136 is illustrated as positionable over different receptacles 150 and 152 in which the harvested food product items 36 are deposited. As in FIG. 5, the hose/tube outlet end 136 may be positioned and moved from receptacle to receptacle by a delta robot 140.

However, the hose/tube outlet end 136 may alternatively be attached to and controlled by a simpler horizontal linear actuator (not shown) that spans above and across the receptacles 150 and 152. Although only two receptacles 150 and 152 are shown in FIG. 5, it can be appreciated that a larger number of receptacles can be utilized so as to more discretely divide the harvested food product items 36 based on one or more selected physical parameters, for example, weight, size, length, width, and/or thickness, etc.

Again, one advantage of the system 20 over typical pick-and-place systems is that the outlet end 136 of the hose/tube 100 need not move back and forth between the conveyor system 24 and the receptacles 150 and 152 in order to position or place the food items at the desired locations. As such, the rate of harvest of the food items from the conveyor system 24 can be very rapid, depending on the size of the food item, from about 200 to at least 400 food items per minute.

As will be appreciated with respect to the embodiment of the present disclosure shown in FIG. 5, the robotic actuator 34 as well as the delta robot 140 are controlled by the controller 40 and utilize information which originated from scanning system 28 to place the portioned workpieces in the correct receptacles 150 and 152 shown in FIG. 5.

The hose/tube 100 is shown in FIGS. 1-5 as being of a continuous, flexible construction. This enables both ends of the hose/tube to be moved about by the robot actuator 34 and the delta robot 140 in a very fast and precise manner. However, it can be appreciated that the hose/tube 100 could be constructed with, at least a portion thereof, rigid tubular material, especially if such portion is not subject to movement. For example, the hose/tube 100 may have a rigid tubular section intermediate the ends thereof which may be composed of flexible tubular material such as a flexible hose. One reason for such a construction is that due to the continuous and rapid movement of the hose/tube ends, over time wear of the hose/tube will occur from such movement as well as due to the food products 22 passing/sliding against the inside wall of the hose/tube when traveling through the interior of the hose/tube.

It will also be appreciated that the diametrical size of the hose/tube may vary depending on the size of the food products being harvested. In this regard, the internal diameter hose/tube can vary from about one-half inch to 3 or more inches to accommodate the size, mass, thickness, and other physical parameters of the food product portions 36 being harvested.

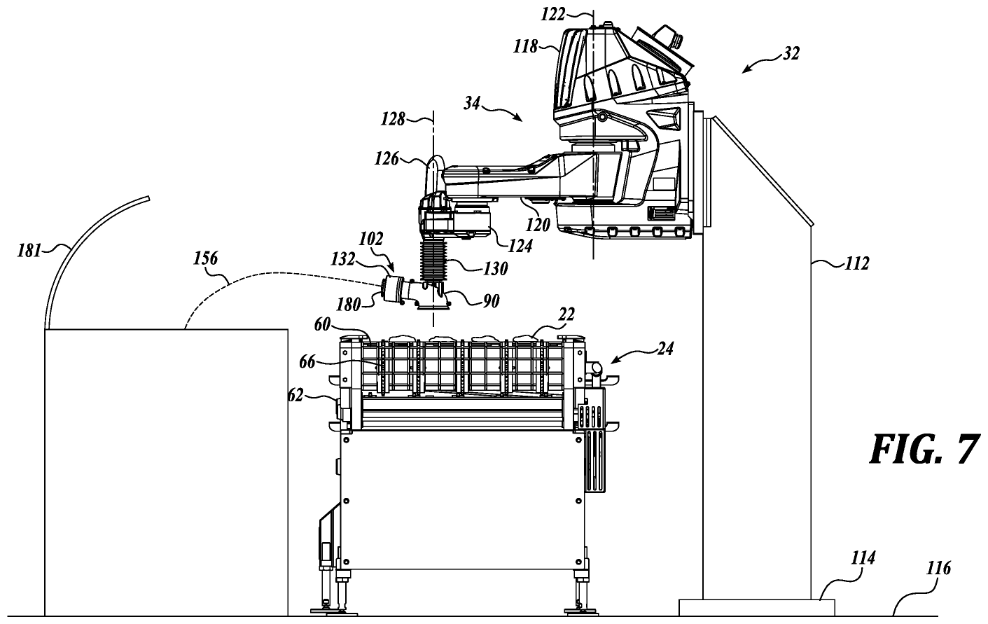

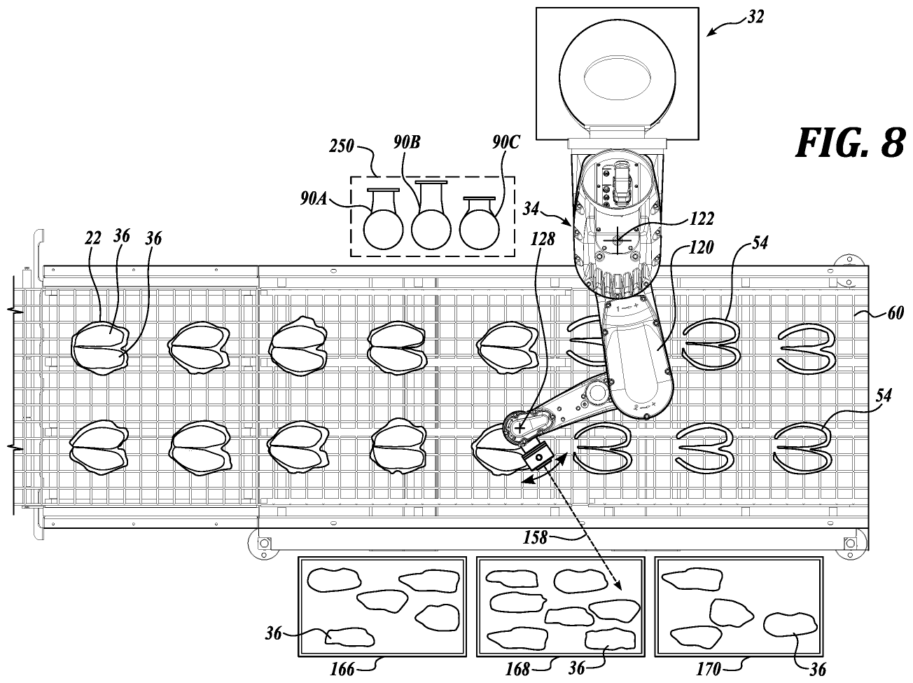

FIGS. 6, 7, and 8 illustrate a further embodiment of the disclosed delivery subsystem 92 which utilizes a ballistic launcher 102 that launches the food items 36 out through an outlet of the launcher in specific trajectories 154, 156, 157, 158 so that the food items land at desired locations, which in FIG. 6 may be on one of three takeaway conveyors 160, 162, and 164, which are positioned at different elevations alongside the conveyor 24. In FIGS. 7 and 8, the ballistic launcher 102 directs the food items in different trajectories, e.g., 156, so as to land in a desired receptacle 166, 168, or 170.

The ballistic launcher 102 is in the form of a short launching barrel 180 that projects a short distance beyond a vacuum generator 132 positioned between the launching barrel and the intake nozzle 90. It will be appreciated that the trajectory of the launched food items can be controlled in different manners, for example, by the rotational position of the nozzle about vertical axis 128 as well as by the level of vacuum generated at the generator 132.

In addition, a six axis robotic actuator can be employed so that the launching barrel 180 can be tilted upwardly and downwardly relative to the horizontal about two axes. As can be appreciated, this may be helpful in achieving the correct launch angle and launch direction and thus the desired trajectory 154, 156, or 157 when desiring to place the food items on conveyors 160, 162, and 164. As shown in FIGS. 6 and 7, backstop screens 181 are used to prevent the launched food items from overshooting the intended conveyor or receptacle

It will be appreciated that the controller 40 is operable to control the position and orientation of the nozzle 90 and thus the launching barrel 180, as well as the level of vacuum generated by vacuum generator 132. In situations in which a six-axis robotic actuator is used, the controller also controls the tilt angle of the launching barrel 180. The controller is aware of the size, shape, weight, and other physical specifications of the workpieces being harvested, and thus is capable of not only directing the delivery subsystem 92 to direct the harvested work product to the correct takeaway conveyor or receptacle, but also functions to control the level of vacuum at the vacuum generator 132 so that the workpiece is launched with the correct level of force or energy so as to successfully arrive at the desired locations.

Pressure sensors 182 and 184 may be mounted on the inlet nozzle 90 as well as on the hose/tube 100 so as to measure the pressure in the nozzle and the hose/tube as part of controlling the level of vacuum generated by the vacuum generator 132. Such pressure sensors can also indicate whether the nozzle 90 and/or the delivery hose/tube 100 may be blocked, partially or fully, so that corrective action, if necessary, may be undertaken. Pressure sensors 182 and 184 are articles of commerce. The outlet signals from the pressure sensors may be routed to the processor 42 and control signals may be routed from the processor by wireless or wired transmission.

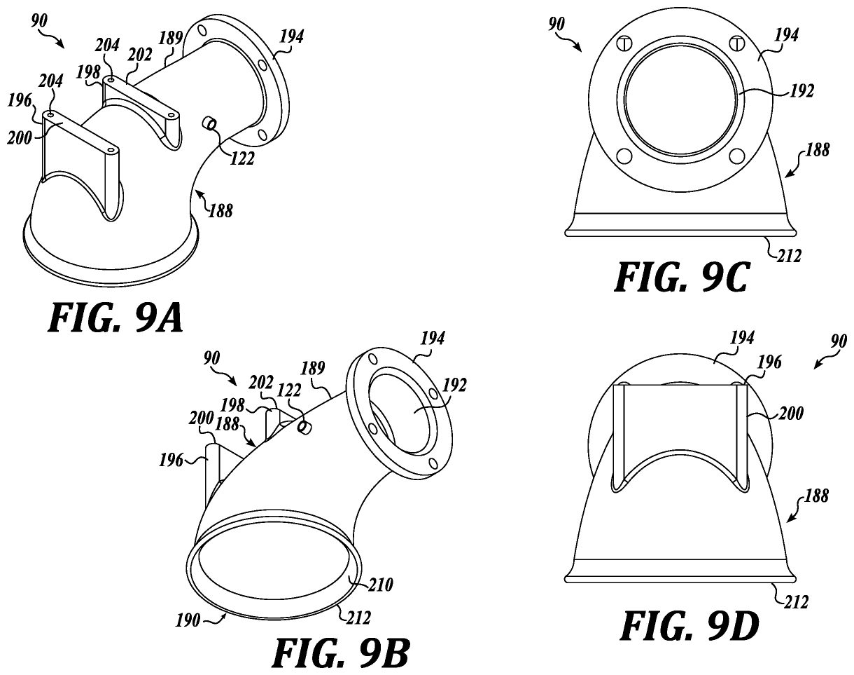

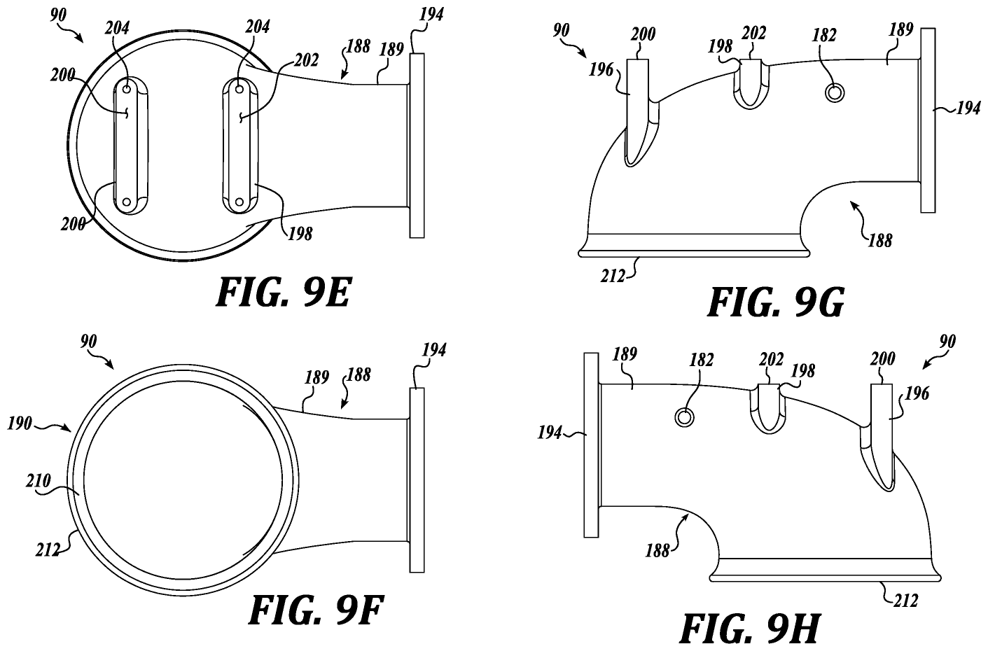

One example of nozzle 90 is shown in FIGS. 9A-9H as constructed generally in the form of an elbow or right angle shape, having a body 188 with downwardly directed opening 190. The body 188 extends upwardly from the opening 190 and then extends laterally to form a neck section 189 with a circular outlet 192 at the distal end thereof. The neck 189 can be of selected length. A flange 194 surrounds the outlet 192 of the nozzle for connection to the vacuum generator 132.

The nozzle 90 is attached to the lower end of the robotic actuator head 126 by a pair of elongate mounting bosses 196 and 198 extending upwardly from the upper surface of the nozzle body to provide attachment surfaces 200 and 202 to bear against the actuator head 126. Hardware members, not shown, extend downwardly from the actuator head 126 to engage within openings 204 formed in the upper surfaces of the bosses 196 and 198.

As noted above, the flange 194 may be connected to the vacuum generator 132 and then delivery hose/tube 100 connected to a stub section projecting from the vacuum generator to engage the inlet end of the hose/tube 100, for example, as shown in FIG. 3. In the nozzle 90 shown in FIG. 3, the outlet 192 is generally horizontal, whereas in FIGS. 6, 7, and 8, the outlet is directed slightly upwardly at a launch angle. This can be achieved by simply adding a short extension to the nozzle shown in FIGS. 9A-9G, or alternatively the nozzle body can be shaped so that the outlet neck 189 is directed somewhat upwardly.

The nozzle body 188 is shown in the figures as having a circular inlet opening 190. As discussed below, the size of the opening can be selected based on the size of the food products being harvested.

The inlet opening 190 is defined by a rim 210 that extends downwardly from the nozzle body. The rim 210 is shown with a bottom edge 212 of the rim can be blunt, squared off, or rounded. Further, as shown in FIG. 14, the edge 212 can be tapered in the downward direction so as to present a sharp bottom edge that may be useful to sever the food product to be harvested from trim or adjacent food product portions that may not have been fully cut by the cutter apparatus but are not to be harvested or are to be separately harvested from the food product piece being harvested.

Further, rather than presenting a uniform or continuous sharp edge in the downward direction, the rim bottom edge 212 may be serrated, toothed, or formed in other patterns or shapes to perform various functions, including separating the food product piece being harvested from the remainder of the food product. In this regard, the actuator head 126 of the robotic actuator may function to rotate the nozzle 90 to create a cutting action at the rim bottom edge 212.

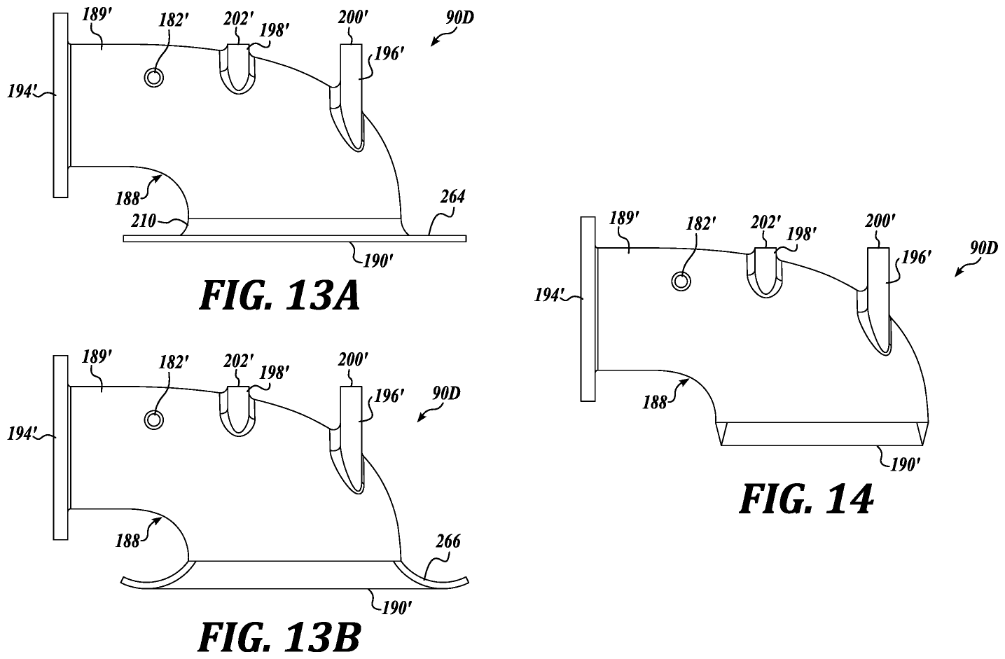

A skirt 264, shown in FIG. 13, may extend around the opening 190 at or near the elevation of the rim 210. The skirt 264 may extend laterally outwardly from the nozzle opening to press against the top of food product other than the portion 36 being harvested, thereby to help ensure that only the harvested portion is drawn into the nozzle 90. In this regard, the skirt may extend or slope downwardly in the outward direction. The skirt may be composed of a flexible material so as not to damage the food product, but still apply a downward pressure on the food product that is sufficient to retain the food product in place while the portion 36 is being drawn into the nozzle.

Also, the skirt may be formed in other configurations than shown in FIG. 13A. For instance, the skirt may be of an upwardly concave shape 266 in cross-section as shown in FIG. 13B so as not to apply pressure to the food item adjacent the nozzle inlet 190, but rather apply a downward pressure on the portion of the food item a desired distance away from the nozzle inlet. Skirts of other shapes or constructions may be utilized than as described above.

As also noted above, pressure sensors, such as sensor 182, can be mounted on the nozzle body 188 to sense the pressure within the nozzle body during operation of the system 20. More than one pressure sensor may be utilized. Further, the pressure sensor may be positioned at locations other than at the location shown in the figures.

As noted above, the size of the nozzle inlet opening is selected based on the area occupied by the food products being harvested. The diameter of the opening 190 can, for example, correspond to no more than the minimum distance across the food products (also known as a “minor dimension”) being harvested so that the food products occupy or overlap the entire area of the opening 190. “Correspondence” in this regard means that the diameter of the nozzle opening is less than the minimum distance across the portion or area of the food product where the nozzle will contact the food product. A major dimension of the food product, for example, the length of the food product, can be significantly longer that the diameter of the nozzle opening, which does not present a problem since the food product will fold upon entering the nozzle, as discussed below.

If the entire area of the nozzle opening is covered by the food product, a maximum suction force being generated at the nozzle opening 190 at the time the food product begins entry into the nozzle 90. This maximum suction force acts on the food product to cause the food product to fold as it enters into the nozzle since the cross-sectional area of the nozzle will be less than the area of the food product as viewed from above. Also, as to nozzle opening is being closed off by the food product, the air speed into the nozzle increases resulting in greater suction being created.

If there is significant friction resistance between the food product and the interior surface of the nozzle, this can be sensed by the pressure sensors 182 so that the controller can cause the vacuum generator 132 to increase the vacuum level at the nozzle opening or air flow level through the nozzle if needed. Moreover, the pressure sensor will also be able to determine if the nozzle is plugged so that remedial action can be undertaken.

The robotic actuator in addition to locating the nozzle 90 over the food product to be harvested also lowers and raises the nozzle relative to the food product. The controller controls the robotic actuator to place the nozzle at a desired elevation relative to the food item to be harvested. Such elevation may depend on the type and physical parameters of the food item being harvested. For example, it may not be required that the nozzle be lowered all the way down to the top surface of the food item. Rather as the nozzle lowers toward the food item, the suction from the nozzle may lift the food item into the nozzle.

The ideal vertical position of the nozzle relative to the food item may depend also on the construction of the conveyor belt 60, for example, whether an open weave belt or a solid metallic or plastic belt. Since, as described herein, the vacuum generated at the nozzle is by the volume of air flow into the nozzle, for a solid surface belt, the nozzle may need to be at a relatively higher elevation than in an open weave belt to allow sufficient air flow into the nozzle to create the necessary lifting force to raise the food product into to nozzle.

As will be appreciated, if the food product does not occupy the entire area, or substantially the entire area, of the nozzle inlet opening 90, there may not be sufficient suction force to lift the food product off the conveyor belt 60 and into the nozzle 90. This could be the result if the minimum dimension (a minor dimension) across the food product being less than the diameter of the nozzle, or perhaps because the nozzle is not placed correctly over the food product.

The placement of the nozzle with respect to the food product is controlled by the controller 40. The controller knows the shape and size of the portioned food product to be harvested as well as the location of the food product portion on the conveyor. The controller is able to position the nozzle 90 over the food product so that the entire area, or substantially the entire area, of the nozzle inlet is covered by the food product, assuming the food product is large enough to do so.

Due to the shape and/or size of the food product or due to imprecise location of the nozzle over the food product, the entire area of the nozzle inlet may not be covered by the food product. In some instances the present system may operate properly if 90% of the nozzle area is covered by the food product. In other instances the present system may operate properly if about 80% of the nozzle area is covered by the food product. In still other situations the present invention may operate properly if about 70% or less of the nozzle inlet area is covered by the food product. Various factors may affect what percent of nozzle area remains uncovered and the present system still operates properly, such as for example the thickness of the food product, the overall size of the food product, the overall mass or weight of the food product, etc.

In addition to controlling the robotic actuator 34 so as to position the nozzle 90 at proper locations when harvesting food products or other work products, the controller may also control the robotic actuator so as to position the center of the nozzle body opening 188 over the centroid of the food product being harvested. This facilitates the entry of the food product into the nozzle body through the inlet opening 190. If the nozzle inlet opening 190 is located too far offset from the centroid of the food product, the possibility exists that the portion of the food product located directly below the opening may be lifted upwardly, but the remainder of the food product may resist upward movement into the nozzle body

As will be appreciated, there may be a difference between the location on the food product where the entire area of the nozzle inlet opening 190 is occupied by the food product and the location of the centroid of the food product. The controller seeks to resolve such difference in optimum location of the nozzle, for example, by moving the nozzle to more closely align the center of the nozzle with the centroid while still keeping the area of the nozzle covered with the food product. An algorithm may be used in this regard that takes into consideration the relative importance of seeking to ensure that the inlet opening of the nozzle is fully covered versus positioning the center of the nozzle over the centroid of the work product.

Although the foregoing factors and considerations with respect to placement of the nozzle 90 over the food product has been discussed with respect to nozzle 90 having a circular inlet opening 190, the same considerations apply to nozzles of other shapes, including those discussed below.

The controller is capable of recognizing whether a food product is either too small or too large or too heavy to be successfully harvested by system 20. If the food product is too small, an inadequate level of suction may be generated to be able to lift the food item into to nozzle. Or if the food product portion is too large in size, weight, mass, etc., the food product may not be able to fold into a small enough configuration to pass through the nozzle and/or the hose/tube. In such case, the controller instructs the harvesting system to not seek to remove such food products from the conveyor system 24, but instead allows the food product to pass by to be perhaps harvested by a robotic actuator with a different size and/or shape nozzle or to allow the food product to be manually harvested.

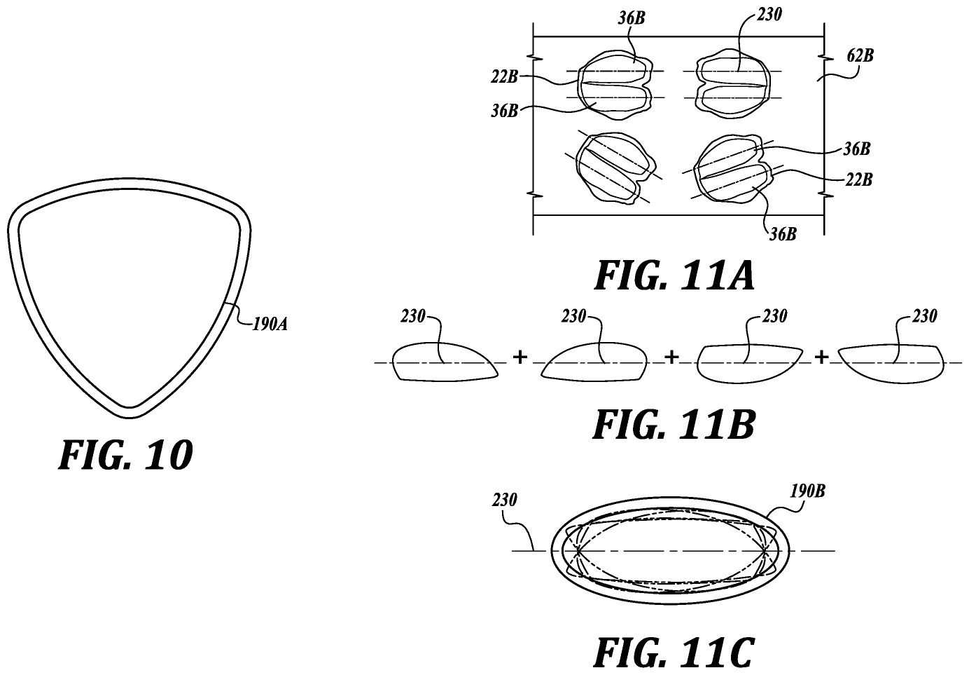

Rather than being circular in shape, the nozzle body opening 190 may be of other shapes, including shapes that correspond to the shape of the food product being harvested. For example, FIG. 10 discloses a nozzle opening 190A which is generally triangular in shape. The opening 190A may be utilized to harvest food products of a shape similar to that shown in FIG. 10. Other potential shapes for the opening 190 may be oval, oblong, semi-circular, etc., to generally match the shape of the food product.

One potential drawback of utilizing a nozzle body opening corresponding to the shape of the food product is that for optimal operation of the system 20, the nozzle opening may need to be oriented to match the orientation of the food product on the conveyor system. Often this is not an issue due to the high speed operation of the robotic actuator 34. The robotic actuator is capable of rotating the nozzle 90 as the actuator head 126 approaches the food product to be harvested so that when the nozzle reaches the food product, it is in proper orientation about vertical axis 128 to match to the orientation of the food product on the conveyor system 24.

However, it may be desirable to shape the nozzle opening so that the nozzle opening may generally correspond to the shape of the food product, but enable to nozzle to approach the food product from more than one direction, or so that the nozzle may be in more than one orientation with respect to the vertical axis 128. For example, in FIG. 11A, the food products 22B may be in different orientations on the conveyor belt 62B. The nozzle opening 190B shown in FIG. 11C may be generally elliptical in shape so as to successfully harvest the depicted food product portions 36B by approaching the food product portions from any direction and aligning the longitudinal axis 230 of the opening 190B with the longitudinal axis of the food product portions 36B. As shown in FIG. 11B, the shape of the nozzle opening 190B is the result of superimposing the shapes of the food product portions 36B on top of each other when positioned in four different orientations. Parts of the food product may extend beyond the margins of the nozzle opening, but the area of the nozzle opening is covered, or substantially covered, by the food product.

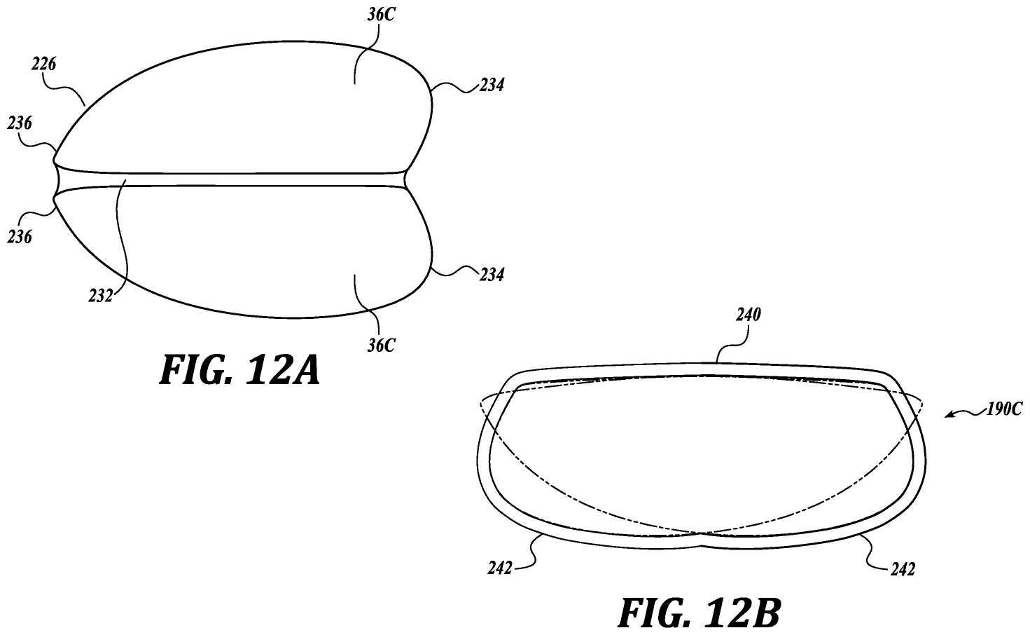

In addition, the nozzle opening may be designed so as to be able to pick up food products of similar complementary shapes. For example, FIG. 12A shows chicken breasts 22C that have been portioned into halves 36C so that the shape of each half is generally in the shape of one half of a heart shape, having a straight side edge 232 that intersects a curved lobe section 234 at the “top” of the chicken breast half which then arcs generally tangentially to the opposite tip end 236 of the straight side edge. The nozzle 190C is formed with a straight edge 240 corresponding to the straight side edge 232 of the chicken breast halves. The nozzle 190C also is formed with curved lobe portions 242 at both ends of the straight edge portion 240 so as to correspond to the lobe portions 234 of both of the chicken breast halves 36C. Thus, the nozzle 190C is able to pick up either of the chicken breast halves 36C shown in FIG. 12A by simply rotating the nozzle about axis 128 so that the straight edge portion 240 of the nozzle opening 190C overlies the straight edge portion 232 of the chicken breast halves 36C shown in FIG. 12. As discussed above, the nozzle is sized so that the entire area of the nozzle opening is covered, or substantially covered, by the chicken breast half. As such, the chicken breast half may extend beyond the outer perimeter of the nozzle opening. This is acceptable, since the chicken breast is pliable and will fold upon entering the nozzle.

Another approach may be to construct the nozzle 90 with dual openings of complementary shapes thereby enabling either of the openings to be utilized depending on the shape of the food product as well as the direction of approach of the nozzle to the food product. Appropriate valving can be provided so that vacuum is applied only to the selected nozzle opening. Such valving can be controlled by the controller 40, which as described herein also functions to control the other aspects of system 20.

Of course, other design considerations may be used to shape the inlet opening of the nozzle 90 in addition to or in lieu of that described above while still taking into consideration the shape of the food items being harvested.

Further, the system 20 can include a number of different nozzles 90A, 90B, 90C located in a storage rack 250 within reach of the robotic actuator 34, as shown in FIG. 8. The nozzles 90A-90C in FIG. 8 are of different sizes and shapes. The robotic actuator 34 can be controlled to select an appropriate nozzle for the food products being harvested. It is possible that such selection and replacement of the nozzle can occur continuously and quickly enough to accommodate changes in the shapes of the food products being carried by the conveyor system.

Another reason for having multiple nozzles is if a nozzle were to become clogged with food product, then that nozzle could be quickly replaced so as not to significantly reduce the harvesting rate of the robotic actuator. The clogged nozzle can be unclogged by personnel and then replaced, for example, in the storage rack 250 for subsequent use by the robotic actuator.

In addition, nozzle 90 may be replaced periodically to be sanitized. While the removed nozzle is being sanitized, a clean nozzle can be quickly coupled to the robotic actuator 34 so as to maintain the harvest rate of the system 20.

As a further alternative, a plurality of robotic actuators that are the same or similar to actuator 34 can be employed, with each actuator operating with nozzles of different size and/or shape openings so as to handle food products of different sizes and shapes. This could be especially beneficial if there is a significant amount of variation in the size and shapes of the food items to be harvested, even though all of the food items are of one particular type, for instance, chicken breasts or boned chicken thighs. As discussed above, for those food pieces that are sufficiently smaller or larger than the available nozzles or of sufficiently dissimilar shape, such outliers could be manually harvested downstream of the plurality of robotic actuators in use.

As a further alternative, nozzles such as nozzle 90 could be constructed with a plurality of openings of different shapes and sizes. Such nozzle could be rotated about vertical axis 128 to present the desired opening to the particular food part portion 36 being harvested. The controller 40 functions to switch the nozzle opening to the one that is to be presented to the food product portion being harvested and automatically disable the other nozzle openings.

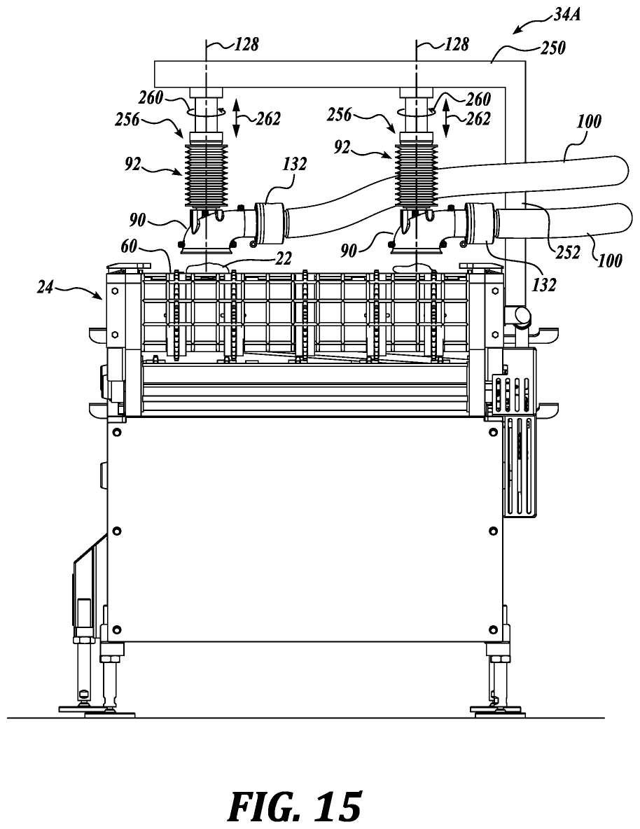

FIGS. 15, 16, 17, and 18 disclose additional embodiments of the present disclosure utilizing various constructions for actuators 34A, 34B, 34C, and 34D. In FIGS. 15-18, the components that correspond to those illustrated and described in FIGS. 1-14 are identified with the same part number and the components that correspond, but are not the same as illustrated in FIGS. 1-14, are identified with the same Arabic prefix but with an alphabetic suffix. For example, the actuator illustrated in FIG. 15 is identified with the part number 34A.

With respect to FIG. 15, actuator 34A includes a pair of nozzles 90 that depend downwardly from an overhead frame structure 250 composed of an upright post 252 extending upwardly from the frame of the conveyor frame 64 to support a horizontal beam 254 that extends laterally across a major portion of the conveyor belt 60. The horizontal beam 254 supports two downwardly depending nozzle mounting assemblies 256. Nozzles 90 are mounted to the lower ends of the mounting assemblies 256 so as to be positioned over a lane of the conveyor on which the food products 22 are positioned.

The mounting assembly 256 can be of various configurations. For example, in a first configuration, the mounting assembly 256 may simply support the nozzle 90 in stationary position over the conveyor belt 60. This configuration is satisfactory if the food product 22 or other work product is positioned fairly accurately along a longitudinal lane of the conveyor belt and that the thickness of the food product or other work product is fairly constant or consistent. In this situation, the control system is operable to generate a vacuum at the nozzle inlet opening 190 when a food product portion 36 to be harvested passes beneath the nozzle opening 190 thereby causing the food product portion to be lifted upwardly from the conveyor belt and into the nozzle 90 in a manner as described above. From the nozzle 90, the food product is transmitted to a delivery location via delivery hose or tube 100.

It will be appreciated that rather than using a delivery hose 100, the nozzle 90 can be adapted to launch the food product portions 36 in specific trajectories so that the food item portions land at desired locations as described above with respect to FIGS. 6, 7, and 8. In this regard, a ballistic launcher, such as launcher 102, can be employed with nozzle 90. It is to be understood that in each of the additional configurations of the actuators 34A-34D shown in FIGS. 15-18, the harvested food product portions 36 can be delivered via the delivery tube such as hose 100 or launched through the air at desired trajectories using a launcher, such as ballistic launcher 102 shown in FIGS. 6, 7, and 8.

Rather than being entirely stationary, the mounting assembly 256 can be rotatable about vertical axis 128, as depicted by arrow 260, thereby to rotate the nozzle opening 190 in response to the shape of the food product portion 36, as described above. As a further alternative, the mounting assembly 256 can be powered to move in a vertical direction as depicted by arrow 262 so that the nozzle opening 190 can be positioned relative to the top surface of the food product portions 36 so as to adjust to the thickness of the food product portion. As a further alternative, the mounting assembly 256 can be adapted to both rotate about vertical axis 128 as depicted by arrow 262 and raise and lower along the axis 128 as depicted by arrow 262. The rotation and vertical movement of the mounting assembly 256 is controlled by the control system 40 in a manner as described above with respect to the embodiments shown in FIGS. 1-14.

Two delivery subsystems 92 are illustrated in FIG. 15 to place nozzles 90 over two parallel lanes along the length of the conveyor belt 60. It is to be understood that the food products 22 may be arranged in a different number of lanes along the length of the conveyor belt 60, for example, three lanes, four lanes, five lanes, etc. In this situation, a delivery subsystem 92 can be provided for each lane. Moreover, to increase harvesting production, more than one delivery subsystem 92 can be placed along a particular lane of the conveyor.

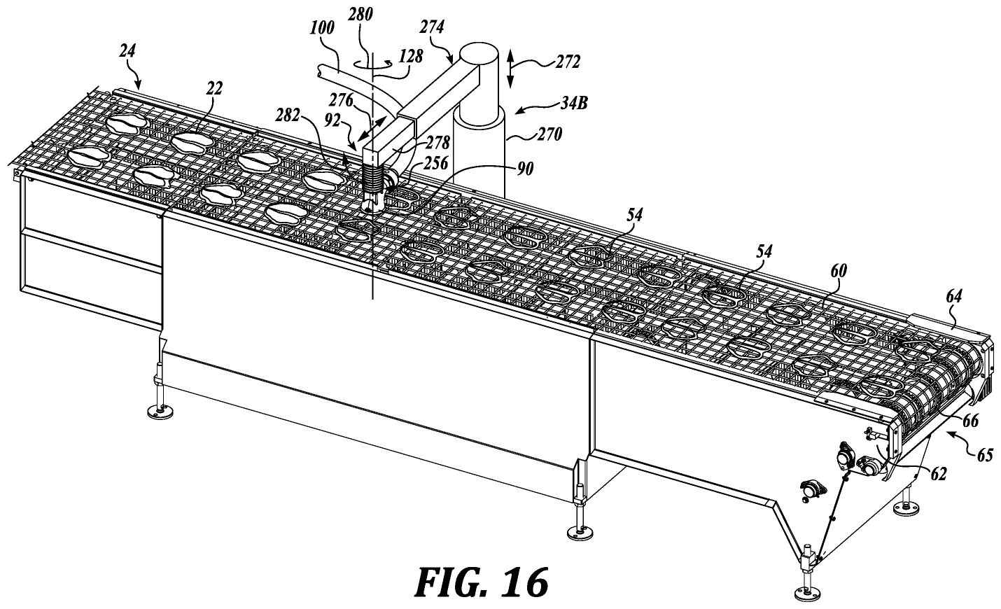

Next, referring to FIG. 16, the actuator 34B is designed to move the nozzle 190 transversely across the width of the conveyor belt 60 and also optionally vertically along the height of axis 128 and also optionally rotationally about the axis 128. To this end, the actuator 34B includes a post structure 270 that can be configured to raise and lower as depicted by vertical arrow 272 or remain vertically stationary. A telescoping beam 274 cantilevers outwardly from the upper end of the post structure 270 to be movable laterally across the conveyor 60 as depicted by arrow 276. The telescoping distal section 278 of the beam 274 may be powered by any known means, for example, hydraulically, pneumatically, electrically, etc.

A mounting assembly 256 projects downwardly from the far end of distal section 278 to support and carry nozzle 90 in a manner similar to that described above with respect to FIG. 15. In this regard, the nozzle 90 can be rotated about axis 128 as depicted by arrow 280 and also move vertically along the height of the axis 128 as depicted by arrow 282. The vertical movement of the mounting assembly 256 can be in lieu of or in addition to the vertical movement of the post structure 270.

As in the embodiment shown in FIG. 15, the movement of the nozzle 90 in FIG. 16 is controlled by control system 40. Moreover, the operation of the nozzle 90 corresponds to that described above with respect to, for example, FIGS. 1-5 and 15.

As will be appreciated, the actuator 34B functions to move the nozzle 90 transversely across the conveyor belt 60, vertically along axis 128, as well as rotationally about axis 128. Moreover, the actuator 34B can be limited to: (1) simply transverse movement across the conveyor 60; or (2) a combination of transverse movement across conveyor 60 and vertical movement along axis 128; or (3) a combination of transverse movement across the conveyor 60 and rotational movement about axis 128; or (4) a combination of transverse movement across the conveyor 60, vertical movement along axis 128 as well as rotational movement about axis 128. As described above with respect to FIG. 15, the required or desired movement of the nozzle 90 can depend upon the nature and uniformity and other physical parameters of the food products 22 or other work products being harvested.

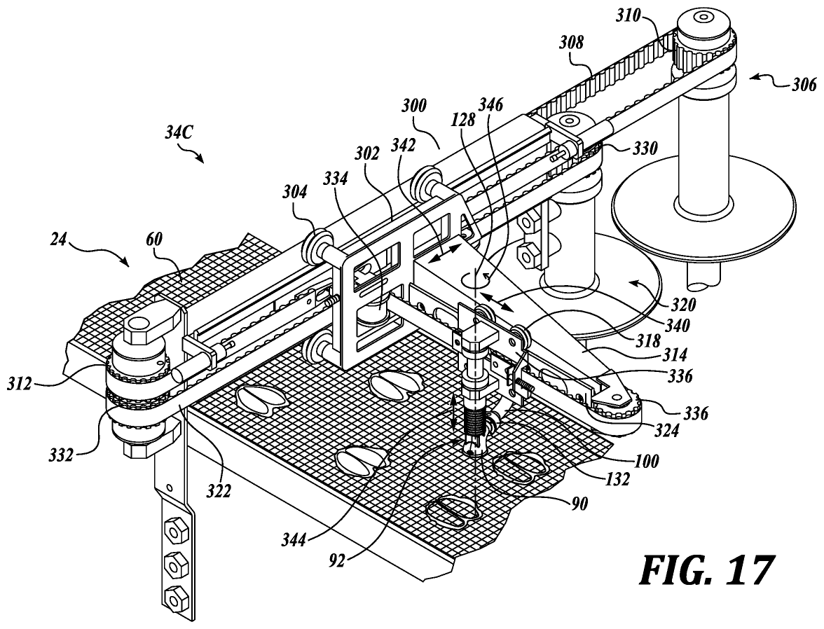

Next, referring to FIG. 17, an actuator 34C is illustrated as enabling movement of the nozzle 90 laterally across the conveyor belt 60, longitudinally along the length of the conveyor belt as well as optionally vertically along the height of axis 128 extending through nozzle 90 and also optionally rotationally about the axis 128. To this end, the actuator 34C includes a support structure 300 extending across the conveyor 24 for supporting and guiding a carriage 302 having wheels 304 for rolling movement along the support structure in a direction transversely to the direction of movement of the conveyor. The carriage 302 is powered by a drive system including, in part, the motive system 306 that powers a drive belt 308 connected to the carriage 302. The belt 308 is powered by drive pulley 310. The belt also trains around an idler pulley 312. A second, longitudinal support structure or beam 314 is cantilevered outwardly from, and carried by, carriage 302 in a direction generally aligned with the direction of movement of the conveyor 24. A second, “longitudinal” carriage 316 is adapted to roll on wheels 318 along the beam 314 by a drive system which in part includes a second motive system 320 to power the longitudinal carriage 316 through a second drive belt 322 connected to carriage 316. An elongated track 324 is mounted on and extends longitudinally on the sidewall of beam 314 to guide wheels 318. The longitudinal carriage 316 is adapted to travel along track 324. The carriage 316 is moved back and forth along track 324 by the second motive system 320, constructed similarly to motive system 306, to power the drive belt 322 connected to carriage 316. The second belt 322 is driven by drive pulley 330. The belt 322 also trains around an idler pulley 332 located across the conveyer 24 from the drive pulley 330. The belt 322 further trains around idler pulleys 334 mounted on carriage 302 and an idler pulley 336 located at the distal end of beam 314.

Mounting assembly 256 functions to mount the nozzle 90 on carriage 316 so as to move with the carriage along the length of the conveyor belt 60 as depicted by arrow 340 as well as move with carriage 302 transversely to the length of the conveyor belt 60 as depicted by arrow 342. Also optionally, the mounting assembly 356 may be adapted to move the nozzle 90 vertically along axis 128 as depicted by arrow 344 along axis 128. Further alternatively, the mounting assembly 356 may be powered to rotate the nozzle 90 about axis 128 as depicted by arrow 346. As in the other actuators described and illustrated herein, the actuator 34C is also controlled by control system 40 as are the motive systems 306 and 320.

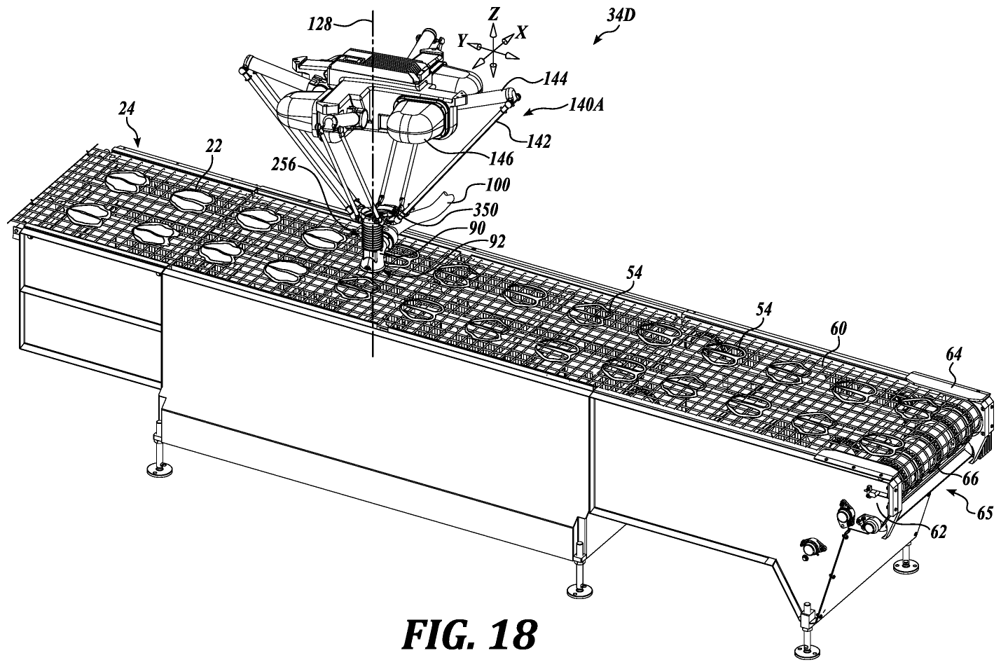

Actuator 34D shown in FIG. 18 is in the form of a delta robot similar to the delta robots shown in FIGS. 4 and 5 and shown above. The components of the delta robot 34D shown in FIG. 18 are identified with the same part numbers as the delta robot shown in FIGS. 4 and 5. Regarding the delta robot 34D, the lower or distal ends of the lower extension arms 142 are connected to a carrier head or attachment 350 for mounting and supporting mounting assembly 256 which in turn supports nozzle 90. The delta robot 34D is capable of moving the nozzle 90 laterally across the conveyor 24, longitudinally along the length of the conveyor, vertically relative to the conveyor, as well as optionally to rotate the nozzle 90 about an axis 128 extending centrally through the nozzle 90. As such, the delta robot 34D is capable of positioning the nozzle 90 very precisely and quickly with respect to food products 22 so as to harvest portions 36 thereof in the same manner as when utilizing the other actuators described above.

The delta robot 34D may be mounted above the conveyor 34. In addition, more than one delta robot may be utilized in the harvesting system 20.

While illustrative embodiments have been illustrated and described above and below, it will be appreciated that various changes can be made therein without departing from the spirit and scope of the invention. Such changes shall keep in mind that the systems of the present disclosure are aimed at processing and/or harvesting various types of food items that may be of variable physical parameters, including size, shape, thickness, weight, etc. and that may also be flexible and pliable so as fold into, or otherwise assume, a cross-sectional size that is smaller than a major dimension (e.g. maximum length) of the food item. Non limiting examples of such food items include raw meat, fish, and poultry. Specific non limiting examples include boneless chicken breasts, boneless chicken thighs and chicken nugget portions.

As another alternative, the systems of the present disclosure may be used to pick up the trim remaining after a food product or other type of workpiece has been cut or portioned. For example, for fragile work pieces, such as some types of fish, the trim could be picked up leaving the desired product on the conveyor belt.

Also, the systems of the present disclosure may be used to remove work pieces other than food items. Such work pieces may include, for example, workpieces composed of fabric, rubber, synthetic rubber, plastic, paper, cardboard, hardware cloth, plant material, and other organic material, biomass, cellulose fiber material, etc.

As a further alternative, sensors other than pressure sensors can be used to sense the presence of work pieces in the delivery subsystem, including if the work pieces are jammed or stuck in the delivery subsystem. Such alternative sensors or sensing systems may include, for example, conductivity sensors, temperature sensors, optical sensors, air flow sensors, position sensors, radar sensors, sonar sensors and accelerometers.

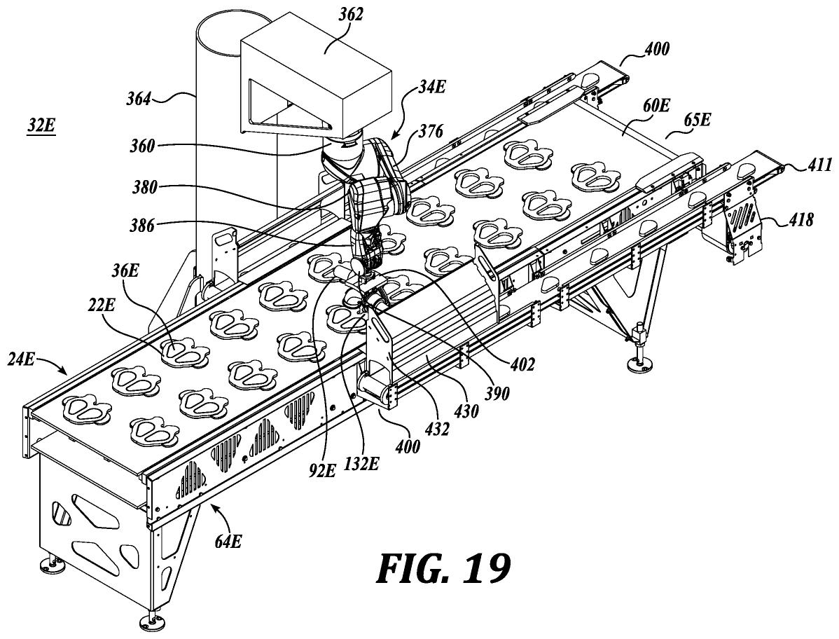

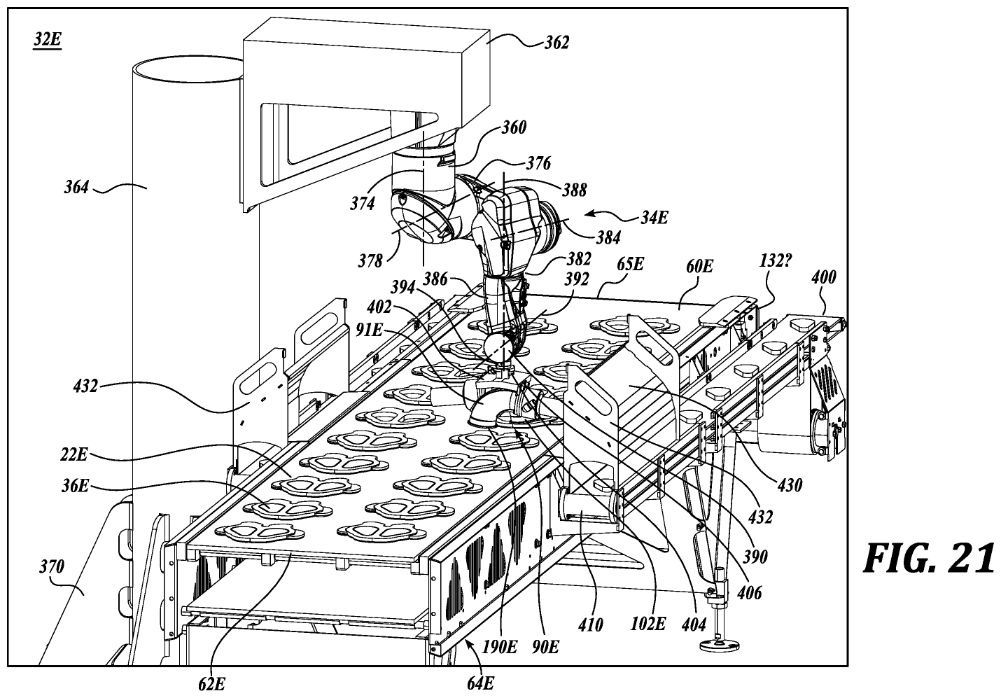

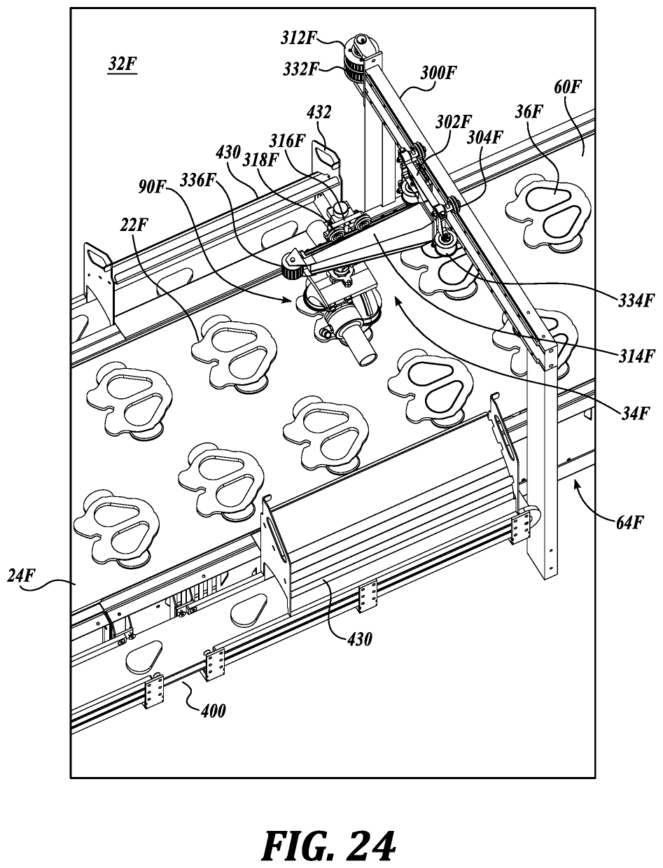

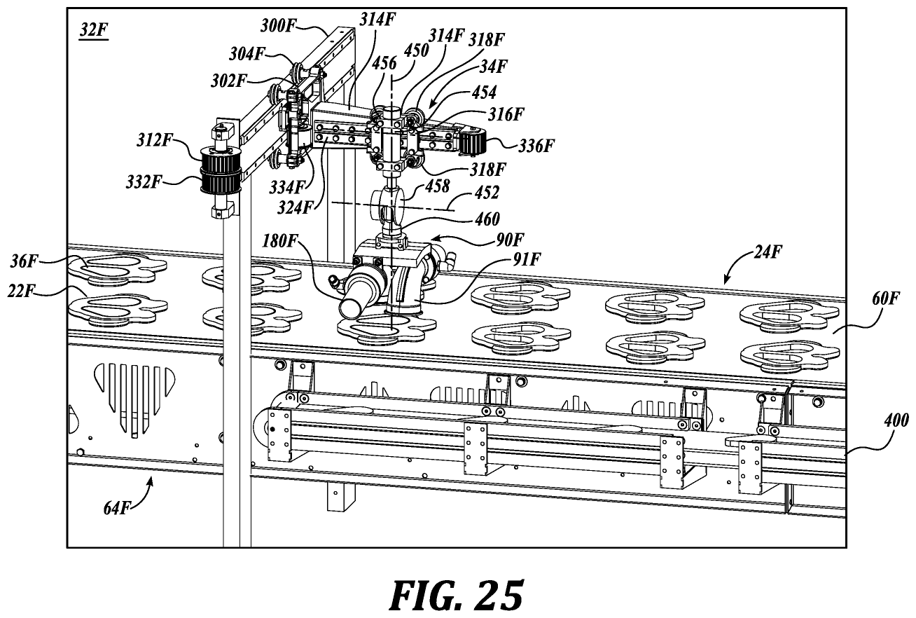

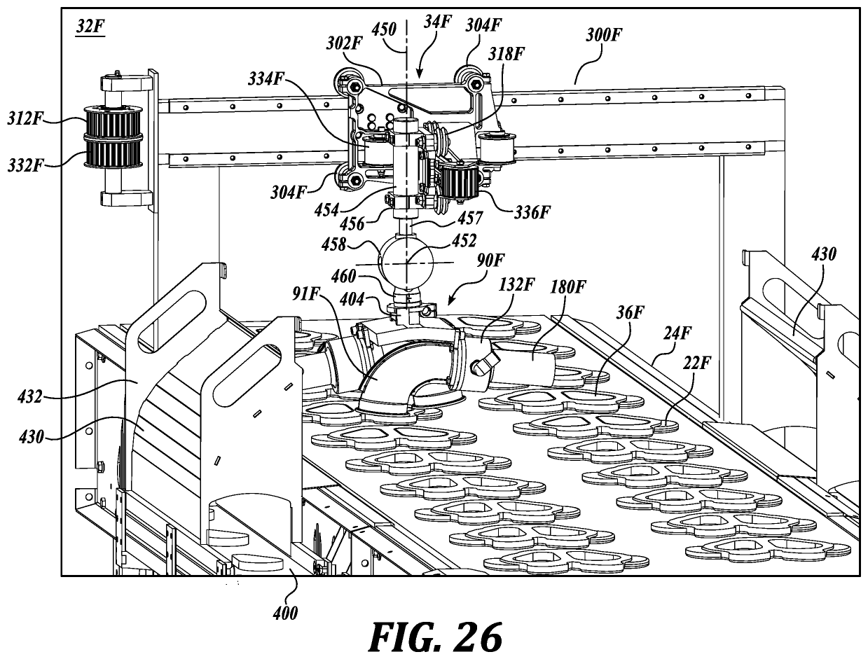

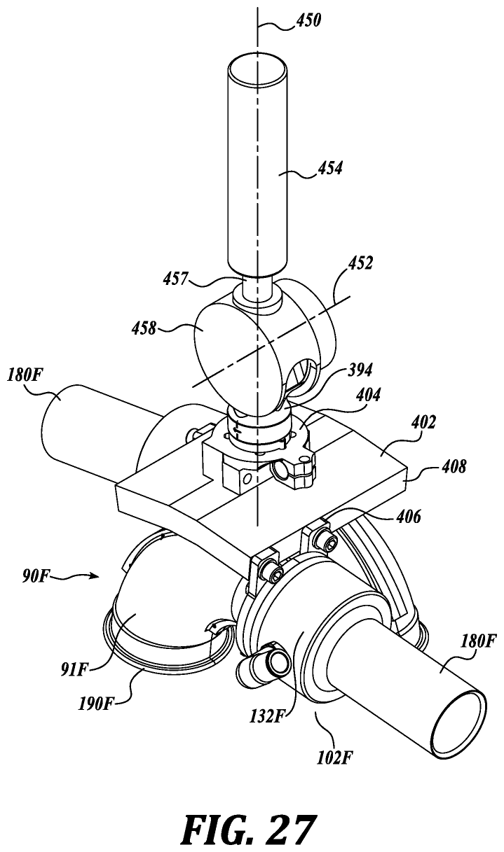

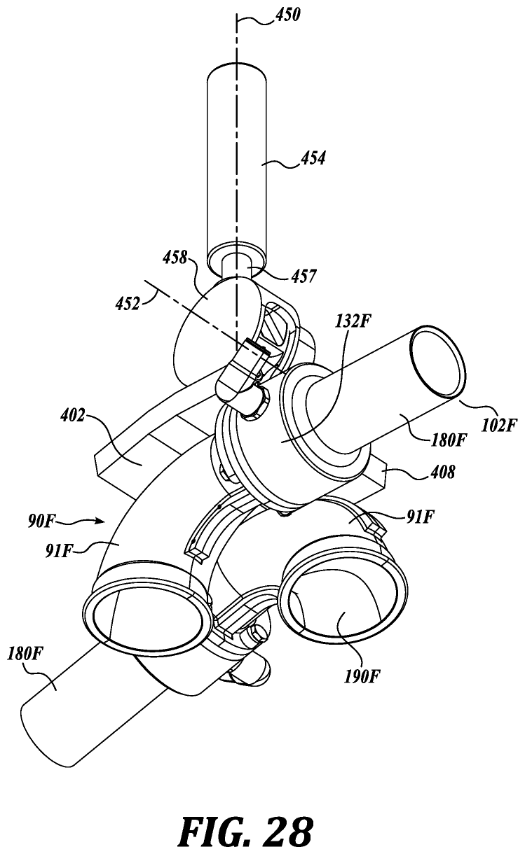

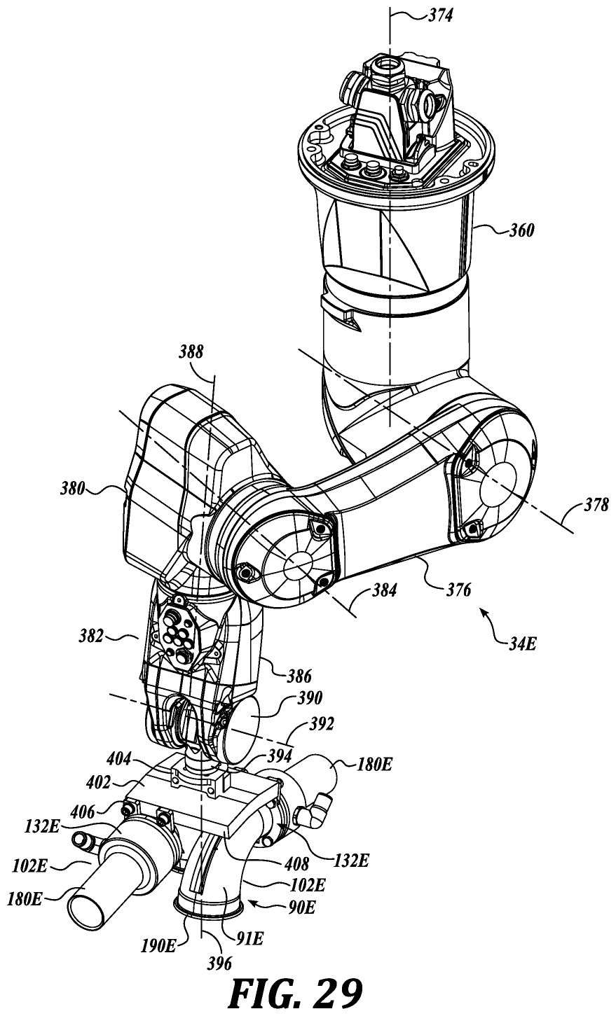

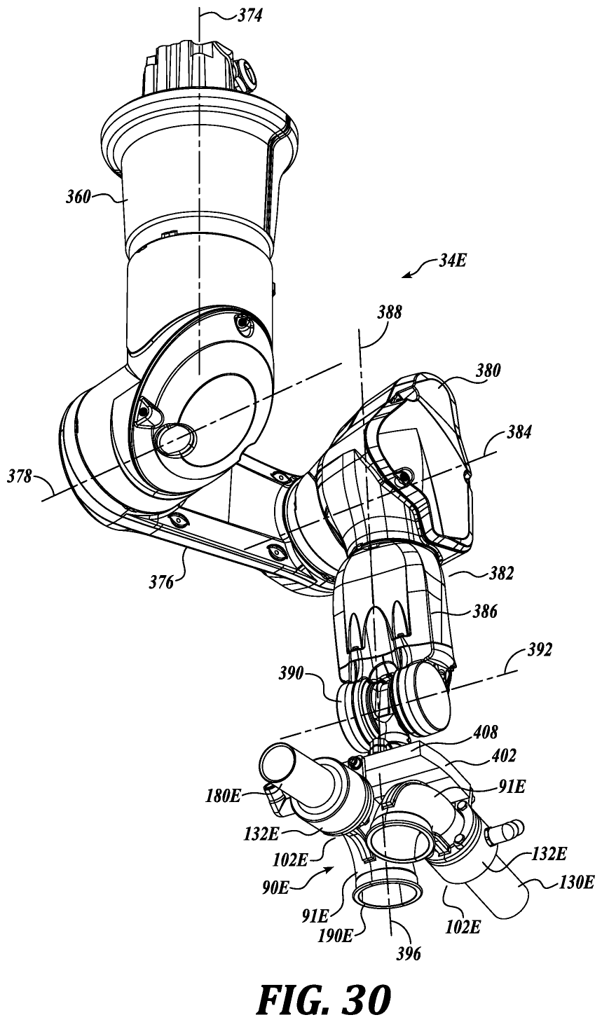

FIGS. 19-30 disclose additional embodiments of the present disclosure utilizing various constructions of harvesting systems. In FIGS. 19-30, the components that correspond to those illustrated and described in FIGS. 1-18 are identified with the same part numbers, and the components that correspond but that are not the same as illustrated in FIGS. 1-18 are identified with the same Arabic prefix but with an alphabetic suffix. For example, the actuator illustrated in FIGS. 19-21, 29, and 30 is identified with the part number 34E.

Referring to FIGS. 19-21, 29, and 30, the harvesting system 32E includes a moving support surface in the form of a conveyance system 24E having a moving belt 60E that slides over an underlying support or bed 62E. The belt 60E is driven by drive rollers (not shown) mounted on a frame structure 64E that also carries the conveyor belt bed 62E. The drive rollers are in turn driven at a selected speed by a drive motor (not shown) in a standard manner. The drive motor can be composed of a variable speed motor to thus adjust the speed of the belt as desired as the food products are carried past a scanning system, a portioning or other type(s) of processing system, and the harvesting system 32E. At the outlet end 65E of the conveyor system 24E, the belt 60E trains around idler rollers 66E mounted on the frame structure 64E in a standard manner.

An encoder, not shown, is integrated into the conveyance system 24E, for example, at the drive rollers to generate electrical pulses at fixed distance intervals corresponding to the forward movement of the conveyor belt 60E. This information is routed to the processor 42 so that the location(s) of the food products 22E, or the portions 36E cut from the food products, can be determined and monitored as the food products or portions travel along the conveyor system 24E. This information can be used to position cutters of the portioning system as well as the components of the harvesting system 32E, including a robotic actuator 34E.

As shown in the FIGS. 19-22, 29, and 30, harvesting system 32E basically includes multi-axis robotic actuator 34E which carries and manipulates a vacuum nozzle assembly 90E which is designed to suck or vacuum up the work product pieces through two nozzles 91E and transmit the work product pieces to a delivery subsystem. The delivery subsystem can be of various configurations, including a delivery tube in the form of a rigid, partially rigid, or flexible tube or hose that is the same or similar to hose 100 shown in FIGS. 1-5 or a ballistic launcher 102E as discussed more fully below.

The robotic actuator 34E includes a base section 360 the depends downwardly from the distal end of an arm structure 362 that cantilevers outwardly from the upper end of an upright cylindrical mounting post 364. The post 364 extends upwardly from a base structure 366 that is secured to floor 368. The base structure 366 is in the form of four channel shaped mounting feet 370 that are secured to the lower end of the post 364. Bolts 372 secure the feet 370 to the floor 368.

The base section 360 is operable to rotate about a vertical axis 374 relative to the arm structure 262. The base section 360 includes a motor disposed within the base section for rotating the inward. proximal end of a first arm 376 about a horizontal axis 378. The motor disposed within the base section 360 can be of various types, including electrically or pneumatically powered to operate the first arm 376.

The distal end of the first arm 376 rotatably coupled to the upper section 380 of the second arm structure 382 to rotate about a second horizontal axis 384. The second arm structure includes a lower section 386 that is rotatable about the upper section 380 about axis 388.

An actuating head 390 is rotatably mounted on the distal end of the lower section 386 of the second arm structure to rotate about a horizontal axis 392. An attachment shaft 394 projects from the actuating head 390 for connection to the nozzle assembly 90E.

The attachment shaft 394 is rotatable about its longitudinal axis 396 which serves as the sixth degree of freedom of the robotic actuator.

Although the robotic actuator 34E is illustrated as having six degrees of freedom, the robotic actuator can be configured with fewer or even more degrees of freedom Having six degrees of freedom allows the nozzle assembly 90E to be tilted about the horizontal, thereby to approach food products 22E at a desired angle to the surface of the conveyor belt 60E.

The vacuum nozzle assembly 90E is in the form of two ballistic launchers 102E positioned side by side and directed in opposite directions to launch the food items 36E toward takeaway conveyors 400 extending along the opposite sides of conveyance system 24E. Of course, the food items 36E can be directed at other targets, for example, at collection bins located alongside the conveyance system 24E.

The ballistic launchers 102E are in the form of a launching barrel 180E that projects a distance beyond a vacuum generator 132E positioned between the launching barrel and an intake nozzle 91E. It will be appreciated that the trajectory of the launched food items can be controlled in different manners, for example, by the rotational position of the launching barrel 180E about a horizontal axis (for example axis 392) and/or a vertical axis (for example, axis 388) as well as by the level of vacuum generated at the generator 132E.

The ballistic launchers 102E are attached to a mounting plate 402, which in turn is attached to the shaft 394 with a collar 404, that clamps or otherwise attaches the mounting plate 402 to the shaft 394. Attachment clips 406 extend around the circumference of the ballistic launcher 102E adjacent the vacuum generator 132E for attaching to an edge 408 of the mounting plate with hardware members.

The collar 404 can be designed to automatically or otherwise conveniently detachably attach the collar 404 to the mounting shaft 394, thereby to conveniently and quickly exchange ballistic launchers when, for example, a different sized food product or a different type of food product is being harvested.

The inlet 190E to the nozzles 91E can be of various shapes, sizes, and constructions, including as discussed above in relation to FIGS. 9A to 14. Further, all of the nozzles 91E attached to the mounting plate 402 do not have to be the same. Rather, the nozzles can be of different shapes, sizes, and construction, so that a single nozzle assembly 90E can be used to harvest different sizes and/or types of food items

It will be appreciated that the controller 40 is operable to control the position and orientation of the nozzles 90E and thus the launching barrels 180E, as well as the level of vacuum generated by vacuum generator 132E. The controller also controls the tilt angle of the launching barrel 180E. The controller is aware of the size, shape, weight, and other physical specifications of the workpieces being harvested, and thus is capable of not only directing the delivery subsystem 92E to direct the harvested work product to the takeaway conveyor 400 or to a receptacle, but also functions to control the level of vacuum at the vacuum generator 132E so that the workpiece is launched with the correct level of force or energy so as to successfully arrive at the desired locations.

As with nozzles assemblies 90E, pressure sensors may be mounted on the inlet nozzles 91E as well as on the delivery hose/tube, if used, so as to measure the pressure in the nozzle and the hose/tube as part of controlling the level of vacuum generated by the vacuum generator 132E. Such pressure sensors can also indicate whether the nozzles 91E and/or the delivery hose/tube may be blocked, partially or fully, so that corrective action, if necessary, may be undertaken. The outlet signals from the pressure sensors may be routed to the processor 42 and control signals may be routed from the processor by wireless or wired transmission.

The takeaway conveyors 400 extend along each side of the conveyor frame structure 64E. The conveyors 400 are shown as extending from the location of the actuator 34E to the past the outlet end 64E of the conveyor 24E. Of course, the takeaway conveyors can be of other lengths.

The takeaway conveyors may intersect with other conveyors that are parallel, transverse, or otherwise angled to the takeaway conveyors to transport of the food items to other locations. Or, the takeaway conveyors may be positioned over a collection bin or other receptacle for receiving the harvested food items.

Also, the takeaway conveyors 400 are shown as being narrower than the conveyor 24E and having belts 410 at an elevation below belt 60E. In this regard, the takeaway conveyors 400 include a support frame 412 that is attached to the frame 64E of the conveyor 24E at various locations along the length of the frame 64E. The takeaway conveyors 400 can be of other widths relative to the width of the conveyor belt 60E. Also, the belts 410 can be positioned at elevations other than as show in FIGS. 19-22.

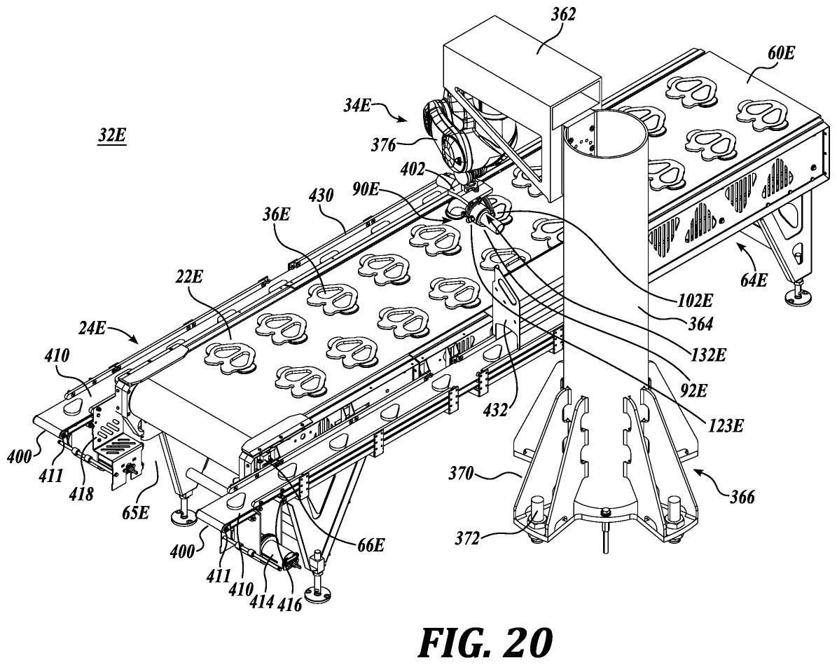

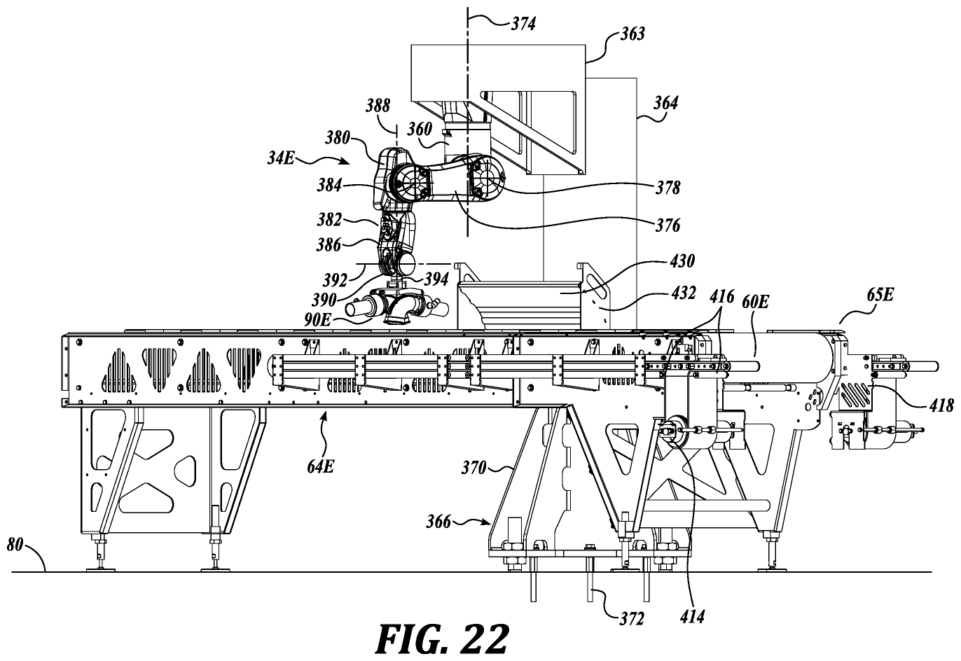

The belts train around end rollers 411 mounted to the ends of the support frame 412. The belts 410 can be driven by numerous different ways, including by a drive roller 414 mounted below elevation of the end roller 411. Idler rollers 416 are provided to guide the belt 410 to and away from the drive roller 414. The drive roller 414 can be powered by numerous means, for example, by an electrical servo motor or a pneumatic motor, etc. A guard structure 418 encloses the drive roller 414, idler rollers 416, and the associated section of the belt 410. In FIGS. 20 and 22 the near side guard structure 418 has been removed so that the drive roller 414 is visible.

Backstops 430 are positioned above the takeaway conveyors 400 to extend along the conveyors at the vicinity of the actuator 34E. The backstops are curved to present a concave surface to the actuator so that food products that are launched by the ballistic launchers 102E will hit the backstops and be directed downwardly onto a takeaway conveyor belt 410. The back stops are mounted to the support frames 412 by end walls 432.

Although a single backstop 430 is shown as “feeding” a single take away conveyor 400, two or even more backstops similar to backstop 430 can be utilized to each feed a take away conveyor. These take away conveyors 400 can be mounted one above the other, or in other positions, along the side of the conveyor 24E. In this manner, the harvester system 32E can also perform a sorting function.

Further, the harvester system 32E can also perform a sorting function if the conveyors 400 were replaced with bins or other receptacles positioned alongside the conveyor 24E. Backstops, similar to backstop 430, can be employed with respect to such bins or other receptacles.

It can be appreciated that the construction of harvester 32E, having two ballistic launchers 102E, can be used to efficiently harvest breast fillets from poultry butterflies. The actuator 34E can position the ballistic launchers accurately over the breast fillets with very little wasted motion. Further, the actuator 34E is capable of harvesting two rows of poultry butterflies extending along the conveyor belt 60E.

Of course, the harvester 32E is capable of harvesting numerous other kinds and types of food items, for example, nuggets or other portions cut from poultry, fish fillets, and other food or nonfood items.

Further, although two ballistic launchers 102 are shown in FIGS. 19-22, 29, and 30, a single ballistic launcher and associated nozzle 91E or more than two ballistic launchers and associated nozzles 91E, for example, 3, 4 or more, may be utilized to harvest food and non-food items. This can enable the nozzle assembly 90E to harvest food items quickly and efficiently with minimum movement of the nozzle assembly. This also has the benefit of less wear on the actuator 34E. Moreover, if one of the nozzle assemblies becomes plugged, harvesting can continue using the remainder of the nozzle assemblies 90E.

Further, the nozzles 91E mounted on the mounting plate 402 can be different sizes, constructions, shapes to better match the specific size, shape, type, etc. of the food product being harvested. The controller 40 can match the optimum nozzle 91E with the specific food product being harvested.

Also, although the ballistic launchers are shown in FIGS. 19-22, 29, and 30 as being disposed side-by-side to each other, they may be positioned in other relative locations. For example, a plurality of ballistic launchers may be positioned so that the launching barrels 180E project radially from an axis, for example the axis 388. In this situation, the actuator 34E rotates to direct a specific launching barrel at a desired direction or target.

The robotic actuator 34E is illustrated as having six degrees of freedom. This enables the actuator to be lowered over a food product to be picked (harvested) by either a vertical movement, or an angled movement of the actuator. With more than one nozzle on the assembly 90E, the vertical movement will lower all (or both) nozzles 91E down close to the food product(s) to suck up the food product(s) unless each nozzle 91E includes an individually controlled vertical actuator with ample clearance relative to the food product(s). If enough clearance is not provided, the non-picking nozzle(s) will/could undesirably contact food products on the conveyor belt 60E, moving or even damaging some of the work products, and/or preventing the nozzle assembly 90E to lower far enough to effectively pick the intended food product.

With the robotic actuator 34E, when the picking nozzle 91E is lowered by tilting down towards the food product, the non-picking nozzle 91E is raised up above the food products on the conveyor belt 60E thereby to desirably avoid the food product. Applicant notes that it could be possible to have both movements of the nozzle assembly—lowering vertically to within reach of the picking nozzle 91E when the picking nozzle is also tilted downwardly.

Also, it if the nozzle assembly 90E is composed of nozzles of different sizes, shapes, or other construction for use with food items of differing sizes or shapes, or types, etc., a nozzle of a particular size or a nozzle for particular type of food item can be used. In this regard, the applicable nozzle assembly 90E can be tilted or otherwise lowered so that the desired nozzle 91E can be utilized, and so the unused nozzles are out of the way.

When a nozzle 90E is tilted it will also tilt the launch barrel 180F of the nozzle and thus may effect the trajectory of the food piece as it is ejected from the nozzle. So, tilting the nozzle can also be used to provide the intended trajectory of the food product.

The tilting/vertical movement of the nozzle assembly 90E can also advantageously be used when harvesting products that are stacked, for example, food products such as poultry portions, poultry nuggets, poultry strips, that are double stacked for portioning or cutting. One nozzle 91E of the assembly 90E can be used to harvest the top portion/nugget/strip and then the nozzle assembly 90E can be tilted or otherwise lowered so that a second nozzle 91E can be used to harvest the beneath portion/nugget/strip. In this manner, the portions/nuggets/strips are not only efficiently harvested, but also are advantageously singulated.

Another potential way to avoid contacting food product (for example, the food product not being picked or trim) on the conveyor belt 60E is to rotate the nozzle assembly 90E around its vertical axis so that the non-picking nozzle(s) is disposed over an empty space in the conveyor belt. This rotation of the nozzle assembly will direct the trajectory of the picked food product either up or down the length of the conveyor belt 60E, which may be desirable or not. Additionally, there may not always be an empty space available next to the food product to be picked.

With a nozzle assembly 90E that can be tilted, and at least two nozzles directing food products to different sides of the conveyor belt 60E, the process of alternating picking steps between the two nozzles 91E and launching to opposite sides of the conveyor belt provides the benefit of spacing the picked pieces apart on the take away conveyors 400 as there is a gap in time between picks for each of the nozzles 91E. This is shown, for example, with spaced, picked food products on the outfeed belts 410 in FIG. 19. This advantage is enhanced by each nozzle 91E discharging to its own take away conveyor 400.

In the disclosed embodiment of the present disclosure, the harvester is capable of performing a picking or harvesting process that successfully fulfills at least the following tasks:

Moving the picking nozzle 91E over the intended target food product and lowering or otherwise positioning the nozzle to pick the target food product.

Avoiding contacting or picking non-targeted food products on the belt 60E. Note that the nozzles 91E may also benefit from having individual vacuum controls to lessen the possibility of inadvertently picking food products or trim with the non-picking nozzle(s) 91E.

Delivering the picked food product to the take away conveyors 400 with a vertical or upward trajectory that allows the food product to reach the desired takeaway conveyor while clearing all obstacles (including other food products on the belt 60E), while also sending or directing the food product up or down the take away conveyor 400 to the correct or desired location along the belt 410 thereby allowing separation of picked food pieces on the belt 410.

The separation or singulation of food products on the outfeed belt 410 can allow much easier use or further processing of the picked food pieces, including manual or automatic inspection, easier sorting of the separated food pieces, easier removal of the food pieces off the belt by, for example, blowing air or sweeping an arm over the belt 410, and easier manual or automatic picking and placing of the food products into packages. Singulation of the picked food products is an important step and has been a problem that has proved difficult to solve in food processing.

Applicant notes that with more degrees of freedom of an actuator, the more control over the actuator is possible to accomplish the steps in the successful picking of food products in a variety of ways. The exact movement of a nozzle 91E vertically and with tilting, and/or rotating, to pick the correct food products, while avoiding all other food product and trim, will depend in part on the size and shape of the food products, and the loading of the food products on the conveyor belt 60E, which can vary moment to moment. Further, the required trajectory to successfully deliver picked food products to a desired location(s) will depend on how many targets (i.e., different sort locations, or belts to deliver the products to), as well as how much space is available at the takeaway belt (e.g., 410) to allow singulation, which also can vary moment to moment.

Path planning for the robot actuator arms to continuously achieve the required movements at high production rates can utilize a variety of different movements (i.e., tilting only, lowering and tilting, rotating and tilting, etc.) to produce the best harvesting results at the highest rate of harvest, and benefits from the multi-nozzle (e.g., dual nozzle) design and as many degrees of freedom as is possible.

The optimum movement using the harvesting system 32E of the present disclosure may also include picking two or more food products simultaneously, each with an associated nozzle 91E, by using a single vertical or downward movement, and then sending the two or more picked food pieces to opposite sides of the belt 60E.

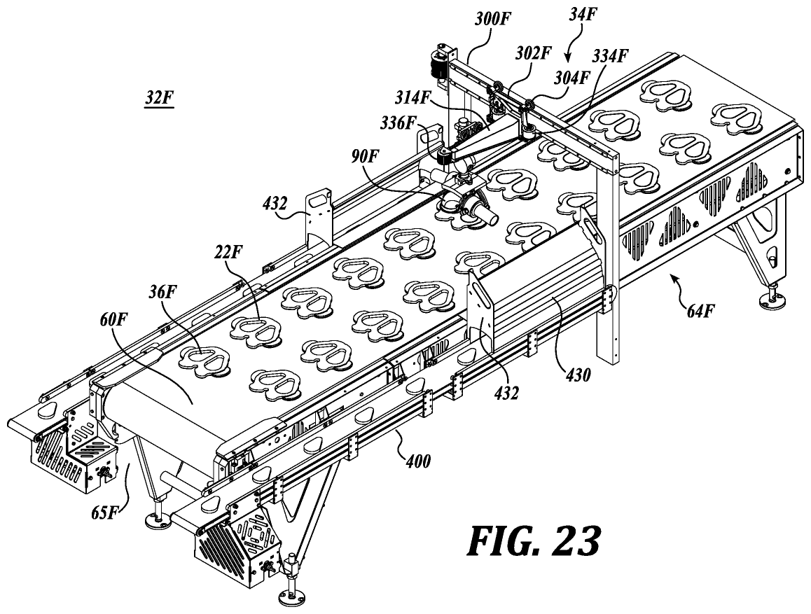

FIGS. 23-28 disclose a harvesting system 32F that is similar to harvesting system 32E, wherein the robotic actuator 34E is replaced with an X-Y actuator 34F similar to actuator 34C, but also with the ability to tilt or rotate about a horizontal axis. As shown in the figures, actuator 34F is illustrated as enabling movement of the nozzle assemblies 90F laterally across the conveyor belt 60F, longitudinally along the length of the conveyor belt 60F, as well as vertically along the height of axis 450, and also optionally rotationally about a vertical axis 450. In addition, the actuator 34F is able to rotate about horizontal axis 452 to thereby present the openings of nozzles 92F at an angle to plane of the conveyor belt 60F, to optimally position the nozzle openings 190F relative to the work product being harvested and also to aim the launching barrels 180F at a desired trajectory.

The actuator 34F is similar in construction to actuator 34C shown in FIG. 17. Certain components of the actuator 34F have been removed for improved clarity of the actuator. As shown in FIGS. 23-26, actuator 34F includes a support structure 300F extending across the conveyor 24F for supporting and guiding a carriage 302F. The carriage 302F includes wheels 304F for rolling movement along the support structure 300F in a direction transversely to the direction of movement of the belt 60F of the conveyor 24F. The carriage 302F is powered by a drive system including, in part, a motive system, similar to the motive system 306, that powers a drive belt connected to the carriage 302F in the manner drive belt 308 shown in FIG. 17. The drive belt is powered by a drive pully similar to drive pulley 310 shown in FIG. 17. The drive belt also trains around an idler pulley 312F, similar to idler pully 312 shown in FIG. 17.

A second, longitudinal support structure or beam 314F is cantilevered outwardly from, and carried by, carriage 302F in a direction generally aligned with the direction of movement of the belt 60F of conveyor 24F. A second, “longitudinal” carriage 316F is adapted to roll on wheels 318F along the beam 314F by a drive system which in part includes a second motive system, similar to motive system 320 shown in FIG. 17, to power the longitudinal carriage 316F through a second drive belt, similar to second drive belt 322, connected to carriage 316F. An elongated track 324F is mounted on and extends longitudinally on the sidewall of beam 314F to guide carriage wheels 318F. The longitudinal carriage 316F is adapted to travel along track 324F.

The carriage 316F is moved back and forth along track 324F by the second motive system to power the second drive belt connected to carriage 316F. The second drive belt is driven by a drive pully similar to drive pulley 330. The second drive belt also trains around an idler pulley 332F located across the conveyer 24F from the second drive pulley. The second drive belt further trains around idler pulleys 334F mounted on carriage 302F and an idler pulley 336F located at the distal of beam 314F.

The actuator 34F includes cylindrical linear actuator 454 that is mounted to the carriage 316F by upper and lower clamps 456 that extend around the circumference of the cylinder of the linear actuator. A reciprocal rod 457 extends down from the cylinder to support a rotational actuator 458. The reciprocal rod functions to raise and lower the rotational actuator 458 up and down along vertical axis 450. The rotational actuator is powered to rotate an attachment shaft 460 about a horizontal axis 452. The attachment shaft 460 functions in the same manner as the attachment shaft 394, described above.

The vacuum nozzle assembly 90F can be the same or similar to the vacuum nozzle assembly 90E, including the mounting to the attachment shaft 460, so its description will not be repeated here.

The carriage 316F of the actuator 34F moves the vacuum nozzle assembly 90F along the length of the conveyor belt 60F, and the carriage 302F moves the vacuum nozzle assembly 90F transversely to the length of the conveyor belt 60F. Also, as noted above, the linear actuator 454 moves the nozzle assembly 90F vertically along axis 450. Further, the linear actuator may be powered to rotate the nozzle assembly 90F about the axis 450. In addition, the rotational actuator 458 functions to tilt or rotate the nozzle assembly 90F about the horizontal axis 452.

Although the actuator 34F has been described as having five degrees of freedom, the actuator can be designed to have more or fewer degrees of freedom to accommodate the types, uniformity, and other aspects of food products being harvested.

Although in FIGS. 23-28 the delivery subsystem is in the form of ballistic launchers 102F, the delivery subsystem can be of various other configurations, including, for example, a delivery tube in the form of a rigid, partially rigid, or flexible tube or hose that is the same or similar to hose 100 shown in FIGS. 1-5. Also, a second actuator that may be in the form of a delta robot similar to robot 140 may be utilized to direct the distal end of the tube or hose to one of more desire locations to direct or place the harvest food product.

As in the other actuators described and illustrated herein, the actuators 34E and 34F are also controlled by control system 40, as are the motive systems of actuator 34F.

The embodiments of the invention in which an exclusive property or privilege is claimed are defined as follows:

1. A harvester for a food processing system wherein variably sized and shaped food items being processed are carried on a moving surface, the food processing system including a scanning system for scanning the food items to generate data pertaining to the physical specifications of the food items, the harvester removing the food items from the moving surface and delivering the removed food items at one or more desired locations, the harvester comprising:
(a) a pickup system for picking up the food items from the moving surface, comprising:
a plurality of nozzles having an inlet configuration based on the food items being receivable into the nozzles;
a discharge subsystem in flow communication with the nozzles; and
a vacuum source for creating a vacuum at the nozzles;
(b) a first actuator to optimally place the nozzles in desired position relative to the food items to facilitate picking up the food items with the nozzles; and
(c) a control system for receiving data from the scanning system pertaining to the physical specifications of the food items and the locations of the food items on the moving surface, and controlling the first actuator to position the nozzles with respect to the food items to enable the nozzles to pick up the food items from the moving surface and controlling the discharge subsystem to place the food items at one or more desired locations.

2. The harvester according to claim 1, wherein the first actuator indexes the nozzles so that the inlet opening of a desired nozzle is presented to the food item harvested in a desired manner.

3. The harvester according to claim 1, wherein the plurality of nozzles having inlet shapes and sizes to correspond to food items of different shapes and sizes, the plurality of nozzles detachably attachable to the actuator.

4. The harvester according to claim 3, wherein the inlets of the nozzles are characterized by one or more of the following:
the shape of the nozzle inlets resemble the shape of the food items when the nozzle is in a specific orientation relative to the food items;
the shape of the nozzle inlets are generalized so that in at least two orientations of the nozzles, the shapes of the nozzles resemble the shapes of the food items;
the sizes and/or shapes of the nozzle inlets are selected to be the same or smaller than the sizes and shapes of food items to be received into the nozzles; and
the sizes and shapes of the nozzle inlets are selected so that the entire area, or substantially the entire area, of the nozzle inlets is covered by the food items to be received into the nozzles.

5. The harvester according to claim 1, wherein the plurality of nozzles are disposed side-by-side to each other.

6. The harvester according to claim 5, wherein the first actuator positions the nozzles to align a nozzle with a desired food item to be harvested, while avoiding the other nozzle(s) from disturbing a food item or food trim.

7. The harvester according to claim 1, wherein the pickup system comprises a ballistic launcher in flow communication with the nozzles to launch food items into the air at a trajectory to delivery of the food items to one or more delivery locations.

8. The harvester according to claim 7, wherein the nozzles are disposed side-by-side to each other.

9. The harvester according to claim 8, wherein the ballistic launcher launches the food items from the nozzles in opposite directions.

10. The harvester according to claim 5, wherein the control system controls the trajectories of the food items launched from the ballistic launchers.

11. The harvester according to claim 5, further comprising at least one removal conveyor located adjacent to the moving surface, and the control system controlling the trajectories of the food items launched from the ballistic launchers to place the food items on the at least one removal conveyor.

12. The harvester according to claim 11, further comprising a back stop shaped to receive the food items launched from the ballistic launchers and direct the food items onto the at least one removal conveyor.

13. The harvester according to claim 11, wherein the control system controlling the trajectories of the food items to place the food items at desired spaced apart locations on the at least one removal conveyor.

14. The harvester according to claim 1, wherein the actuator is capable of moving the nozzle in one or more directions selected from the group consisting of:
rotatable about an upright axis relative to the moving surface;
rotatable about an axis extending parallel to the moving surface;
in an upright direction transverse to the moving surface;
in a direction transverse to the direction of travel of the moving surface; and
in a direction along the directional travel of the moving surface.

15. The harvester according to claim 1, wherein the discharge subsystem comprises a tubular member in fluid communication with the nozzles, the tubular member having an outlet directed at, or directable to, a desired direction or to a desired location for delivery of the food items.

16. The harvester according to claim 15, further comprising a second actuator acting on the outlet of the tubular member to direct the outlet at a desired direction or to a desired location for the delivery of the food items.

17. The harvester according to claim 1, wherein the control system controls the actuator to position the nozzles with respect to the food items based on seeking to position the nozzle inlets so that the entire area of the nozzle inlets, or as much of the area of the nozzle inlets as possible, are within the perimeter of the food items, and so that the center of the nozzles coincide or nearly coincide with the centroids of the food items.

18. A food processing system for processing food items, comprising:
(a) a scanning system for scanning the food items on a moving surface and generating data pertaining to the physical specifications of the food items and the locations of the food items on the moving surface;
(b) the harvester according to claim 1 for harvesting the food items on the moving surface.

19. The food processing system according to claim 18, further comprising:
a food processing station located upstream from the harvester to process the food items being carried by the moving surface; and
wherein the control system receiving data from the scanning system pertaining to the physical specifications of the food items germane to the processing of the food items at the food processing station and controlling the processing of the food items at the food processing station.

20. The food processing system according to claim 19, wherein:
the food processing station comprises a cutting system for cutting one or more portions from the food items; and
the control system directing the cutting system to perform the required cuts of the food items.

21. The food processing system according to claim 19, wherein the physical specifications include at least one of the size and shape of the food items.
